(19) United States
(12) Patent Application Publication
(10) Pub. No.: US 2026/0253317 A1
(43) Pub. Date: Aug. 27, 2026

(54) SYSTEMS AND METHODS FOR STEREO THREE DIMENSIONAL RECONSTRUCTION

(71) Applicant: NAVER CORPORATION, Seongnam-si (KR)

(72) Inventors: Jérome REVAUD, Meylan (FR); Wonbong JANG, Meylan (FR); Philippe WEINZAEPFEL, Montbonnot-Saint-Martin (FR); Vincent LEROY, Laval-en-Belledonne (FR); Yohann CABON, Montbonnot-Saint-Martin (FR); Lucas STOFFL, Kumhausen (DE); Leonid ANTSFELD, Saint Ismier (FR); Gabriela CSURKA KHEDARI, Meylan (FR); Boris CHIDLOVSKII, Meylan (FR)

(73) Assignee: NAVER CORPORATION, Seongnam-si, (KR)

(21) Appl. No.: 19/530,284

(22) Filed: Feb. 4, 2026

Related U.S. Application Data
(60) Provisional application No. 63/764,253, filed on Feb. 27, 2025.

(51) Int. Cl. G06T 15/20; G06T 7/33; G06T 7/579; G06T 17/00; G06V 10/74; G06V 10/82

(52) U.S. Cl. CPC G06T 15/205; G06T 7/337; G06T 7/579; G06T 17/00; G06V 10/761; G06V 10/82; G06T 2207/10016; G06T 2207/20084; G06T 2207/30244

(57) ABSTRACT

A computer-implemented method for reconstructing a scene in three dimensions from a plurality of images acquired using an imaging device, includes: receiving three or more images without receiving extrinsic or intrinsic properties of the imaging device; and processing the three or more images using a neural network, including an encoder and a single Siamese decoder, to generate three or more pointmaps of the scene that correspond to the three or more images and that are aligned in a common coordinate frame, where each pointmap is a one-to-one mapping between pixels of one of the three or more images and three-dimensional points of the scene.

### CROSS-REFERENCE TO RELATED APPLICATIONS

This application claims the benefit of U.S. Provisional Application No. 63/764,253, filed on Feb. 27, 2025. The entire disclosure of the application referenced above is incorporated herein by reference.

### FIELD

The present application relates to neural networks for processing images. More particularly, the present application relates to systems and methods for generating a three-dimensional (3D) representation of a scene from a plurality of images of one or more viewpoints of the scene.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Image-based three-dimensional (3D) reconstruction from one or multiple views (e.g., images) aims at estimating the 3D geometry and camera parameters of a particular scene, given a set of images of the scene. Such a 3D reconstruction task have numerous applications including: mapping, navigation, archaeology, cultural heritage preservation, robotics, and 3D vision. 3D reconstruction may involve assembling a pipeline of different methods including: keypoint detection and matching, robust estimation, Structure-from-Motion (SfM), Bundle Adjustment (BA), and dense Multi-View Stereo (MVS). SfM and MVS pipelines involve solving a series of sub-problems including: matching points, finding essential matrices, triangulating points, and densely re-constructing the scene. One disadvantage of the above is that each sub-problem may not be solved faultlessly, possibly introducing noise to subsequent steps in the pipeline. Another disadvantage of the above is the inability to solve the monocular case (e.g., when a single image of a scene is available).

There is consequently a need for improved systems and methods for image-based 3D reconstruction.

### SUMMARY

In a feature, a computer-implemented method for reconstructing a scene in three dimensions from a plurality of images acquired using an imaging device includes: receiving three or more images without receiving extrinsic or intrinsic properties of the imaging device; and processing the three or more images using a neural network, including an encoder and a single Siamese decoder, to generate three or more pointmaps of the scene that correspond to the three or more images and that are aligned in a common coordinate frame, where each pointmap is a one-to-one mapping between pixels of one of the three or more images and three-dimensional points of the scene, and where the neural network further includes memory used by the single Siamese decoder in the generation of the three or more pointmaps.

In further features, the single Siamese decoder shares weights across the three or more images.

In further features, the neural network further includes a Siamese head configured to generate the three or more pointmaps.

In further features, the method further includes linearly projecting outputs of the encoder and inputting the linearly projected outputs to the decoder.

In further features, the method further includes adding a learnable embedding to the linearly projected outputs and inputting to the decoder the linearly projected outputs and the learnable embedding.

In further features, the memory is selectively updated with information from one or more of the three or more images upon determining that the one or more of the three or more images includes a new part of the scene or a different viewpoint of the scene.

In further features, the method further includes selectively updating the memory for a layer of the decoder at a time based on a concatenation of (a) the memory for the layer at a last time and (b) an input to the layer at the time.

In further features, the method further includes feeding back an input to a last layer of the decoder to an input of a layer of the decoder that is arranged before the last layer of the decoder.

In further features, the method further includes feeding back an input to a last layer of the decoder to inputs of all layers of the decoder that are arranged before the last layer of the decoder.

In further features, the decoder includes at least three decoder layers.

In further features: the receiving three or more images includes receiving a time series of images including more than three images; and the computer-implemented method further includes: segmenting the time series of images into segments of the images, each of the segments including a predetermined number of images that are also included in at least one other one of the segments, processing the segments using the neural network to generate pointmaps of the scene that correspond to the segments.

In further features, the method further includes aligning the pointmaps of the segments.

In further features, the segmenting includes segmenting the time series of images into segments each including a second predetermined number of the images of the time series, wherein the predetermined number is less than the second predetermined number.

In further features, the predetermined number is one-quarter of the second predetermined number.

In further features, the method further includes aligning the pointmaps in the common coordinate frame.

In further features, the aligning includes aligning the pointmaps based on poses of the imaging device for the segments, respectively.

In further features, the method further includes: creating a structure of image descriptors for the segments; for each image descriptor, performing a nearest neighbor search in the structure; determining similarity scores between pairs of images in the segments; identifying pairs of images with similarity scores that are greater than a predetermined value; identifying two of the segments as a loop based on the two of the segments having at least a third predetermined number of the pairs with similarity scores greater than the predetermined value; forming a new segment based on first ones of the images surrounding the pairs of images; and processing the new segment using the neural network to produce a new pointmap of the scene that corresponds to the new segment.

In further features, the method further includes aligning the new pointmap with the pointmaps in the common coordinate frame.

In further features, the alignment includes aligning based on poses of the imaging devices.

In further features, the three or more images are overlapping segments of a time series of images.

In a feature, a system for reconstructing a scene in three dimensions from a plurality of images acquired using an imaging device includes: one or more processors; and memory including code that, when executed by the one or more processors, perform to: receive three or more images without receiving extrinsic or intrinsic properties of the imaging device; and process the three or more images using a neural network including an encoder and a single Siamese decoder, to generate three or more pointmaps of the scene that correspond to the three or more images and that are aligned in a common coordinate frame, where each pointmap is a one-to-one mapping between pixels of one of the three or more images and three-dimensional points of the scene, and where the neural network further includes memory used by the single Siamese decoder in the generation of the three or more pointmaps.

In further features, the single Siamese decoder shares weights across the three or more images.

In further features, the neural network further includes a Siamese head configured to generate the three or more pointmaps.

In further features, the code, when executed by the one or more processors, further performs to linearly project outputs of the encoder and input the linearly projected outputs to the decoder.

In further features, the code, when executed by the one or more processors, further performs to add a learnable embedding to the linearly projected outputs and input to the decoder the linearly projected outputs and the learnable embedding.

In further features, the memory is selectively updated with information from one or more of the three or more images upon determining that the one or more of the three or more images includes a new part of the scene or a different viewpoint of the scene.

In further features, the code, when executed by the one or more processors, further performs to selectively update the memory for a layer of the decoder at a time based on a concatenation of (a) the memory for the layer at a last time and (b) an input to the layer at the time.

In further features, the code, when executed by the one or more processors, further performs to feed back an input to a last layer of the decoder to an input of a layer of the decoder that is arranged before the last layer of the decoder.

In further features, the code, when executed by the one or more processors, further performs to feedback an input to a last layer of the decoder to inputs of all layers of the decoder that are arranged before the last layer of the decoder.

In further features, the decoder includes at least three decoder layers.

In further features, the code, when executed by the one or more processors, performs to: receive a time series of images including more than the three or more images; segment the time series of images into segments of the images, each of the segments including a predetermined number of images that are also included in at least one other one of the segments; and process the segments using the neural network to generate pointmaps of the scene that correspond to the segments.

In further features, the code, when executed by the one or more processors, performs to align the pointmaps of the segments.

In further features, the code, when executed by the one or more processors, performs to segment the time series of images into segments each including a second predetermined number of the images of the time series, wherein the predetermined number is less than the second predetermined number.

In further features, the predetermined number is one-quarter of the second predetermined number.

In further features, the code, when executed by the one or more processors, performs to align the pointmaps in the common coordinate frame.

In further features, the code, when executed by the one or more processors, performs to align the pointmaps based on poses of the imaging device for the segments, respectively.

In further features, the code, when executed by the one or more processors, performs to: create a structure of image descriptors for the segments; for each image descriptor, perform a nearest neighbor search in the structure; determine similarity scores between pairs of images in the segments; identify pairs of images with similarity scores that are greater than a predetermined value; identify two of the segments as a loop based on the two of the segments having at least a third predetermined number of the pairs with similarity scores greater than the predetermined value; form a new segment based on first ones of the images surrounding the pairs of images; and process the new segment using the neural network to generate a new pointmap of the scene that corresponds to the new segment.

In further features, the code, when executed by the one or more processors, performs to align the new pointmap with the pointmaps in the common coordinate frame.

In further features, the alignment includes aligning based on poses of the imaging devices.

In further features, the three or more images are overlapping segments of a time series of images.

In a feature, a computer-implemented method for reconstructing a scene in three dimensions from a plurality of images of one or more viewpoints of the scene acquired using one or more imaging devices includes: (a) decoding a first image and a second image; (b) concatenating the decoded first and second images to form a memory; (c) encoding a third or subsequent image; (d) applying a sequence of decoder layers with cross-attention to the third or subsequent image and the memory; (e) for the third or subsequent image, computing a pointmap of the scene corresponding to such third or subsequent image that is aligned in a common coordinate frame that is common with the first image, the second image and the third or subsequent image; (f) determining whether to add the third or subsequent image to the memory based when the third or subsequent image includes a new part of the scene or a different viewpoint of the scene; (g) repeating (c)-(f) for each of the plurality of images subsequent to the third image; and (h) outputting the pointmaps of the scene that are aligned in the common coordinate frame that is common with the first image, the second image, the third image and any subsequent image processed at (g), wherein each pointmap is a one-to-one mapping between pixels of one of the plurality of images and three-dimensional points of the scene.

In further features, the plurality of images are processed without extrinsic or intrinsic properties of the one or more imaging devices.

In further features, the plurality of images are processed with at least one of (a) intrinsics of the one or more imaging devices, (b) depth maps for the plurality of images, and (c) a relative pose of the one or more imaging devices.

In further features, the method further includes: computing, for one or more of the plurality of images, a local pointmap; and recovering a focal depth using the local pointmap.

In further features, the memory forms part of the sequence of decoder layers with cross-attention.

In further features, the determining further includes determining to add the third or subsequent image to the memory at (f) when the new part of the scene or the different viewpoint of the scene is above a threshold discovery rate, and where adding the third image or subsequent image to the memory at (g) further includes concatenating output of said applying at (d) to the memory.

In further features, the method further includes performing one of the following applications using the plurality of pointmaps of the scene: (i) rendering a pointcloud of the scene for a given camera pose; (ii) recovering camera parameters of the scene; (iii) recovering depth maps of the scene for a given camera pose; and (iv) recovering three dimensional meshes of the scene.

In further features, the plurality of images are overlapping segments of a time series of images.

In a feature, a computer-implemented method for reconstructing a scene in three dimensions from a plurality of images of the scene, includes: receiving the plurality of images; and processing the plurality of images, and at least one of (a) intrinsics of one or more imaging devices, (b) depth maps for the plurality of images, and (c) a relative pose of the one or more imaging devices, using a neural network to produce a plurality of pointmaps of the scene that correspond to the plurality of images and that are aligned in a common coordinate frame, where each pointmap is a one-to-one mapping between pixels of one of the plurality of images and three-dimensional points of the scene.

In further features, the processing includes processing the plurality of images, and at least two of (a) the intrinsics of the one or more imaging devices, (b) the depth maps for the plurality of images, and (c) the relative pose of the one or more imaging devices, using the neural network to produce the plurality of pointmaps of the scene that correspond to the plurality of images and that are aligned in the common coordinate frame.

In further features, the processing includes processing the plurality of images, and all of (a) the intrinsics of the one or more imaging device, (b) the depth maps for the plurality of images, and (c) the relative pose of the one or more imaging devices, using the neural network to produce the plurality of pointmaps of the scene that correspond to the plurality of images and that are aligned in the common coordinate frame.

In further features, the processing includes processing the plurality of images, and (a) the intrinsics of the one or more imaging devices, and where the computer-implemented method further includes inputting the intrinsics to encoders of the neural network.

In further features, each encoder includes a plurality of encoder blocks that each include a self attention module, at least two adder modules, and a multi-layer perceptron (MLP) module.

In further features, the processing includes processing the plurality of images, and (a) the depth maps, and where the computer-implemented method further includes inputting the depth maps to encoders of the neural network.

In further features, each encoder includes a plurality of encoder blocks that each include a self attention module, at least two adder modules, and a multi-layer perceptron (MLP) module.

In further features, the processing includes processing the plurality of images, and the relative pose, and where the computer-implemented method further includes inputting the relative pose to decoders of the neural network.

In further features, each decoder includes a plurality of decoder blocks that each include a self attention module, at least three adder modules, a cross attention module, and a multi-layer perceptron (MLP) module.

In further features, the method further includes processing for a first and second images of the plurality of images, the second image, and at least one of (a) the intrinsics of one of the one or more imaging devices, (b) the depth map for the second image, and (c) the relative pose, using the neural network, which produced a first and a second pointmaps corresponding to the first and second images, to produce a third pointmap of the scene that corresponds to the first and second images, where the third pointmap is a one-to-one mapping between pixels of one of the second image and three-dimensional points of the scene.

In further features, the plurality of images are acquired using the one or more imaging devices.

In further features, the method further includes performing one of the following applications using the plurality of pointmaps of the scene: (i) rendering a pointcloud of the scene for a given camera pose; (ii) recovering camera parameters of the scene; (iii) recovering depth maps of the scene for a given camera pose; and (iv) recovering three dimensional meshes of the scene.

In a feature, a system for reconstructing a scene in three dimensions from a plurality of images of one or more viewpoints of the scene acquired using one or more imaging devices, includes: one or more processors; and memory including code that, when executed by the one or more processors, performs to: receive a plurality of images; and process the plurality of images, and at least one of (a) intrinsics of the one or more imaging devices, (b) depth maps for the plurality of images, and (c) a relative pose of the one or more imaging devices, using a neural network to produce a plurality of pointmaps of the scene that correspond to the plurality of images, respectively, and that are aligned in a common coordinate frame, where each pointmap is a one-to-one mapping between pixels of one of the plurality of images and three-dimensional points of the scene.

In further features, the code, when executed by the one or more processors, performs to process the plurality of images, and at least two of (a) the intrinsics of the one or more imaging devices, (b) the depth maps for the plurality of images, and (c) the relative pose of the one or more imaging devices, using the neural network to produce the plurality of pointmaps of the scene that correspond to the plurality of images, respectively, and that are aligned in the common coordinate frame.

In further features, the code, when executed by the one or more processors, performs to process the plurality of images, and all of (a) the intrinsics of the one or more imaging devices, (b) the depth maps for the plurality of images, and (c) the relative pose of the one or more imaging devices, using the neural network to produce the plurality of pointmaps of the scene that correspond to the plurality of images and that are aligned in the common coordinate frame.

In further features, the code, when executed by the one or more processors, performs to process the plurality of images, and (a) the intrinsics of the one or more imaging devices, and to input the intrinsics to encoders of the neural network.

In further features, each encoder includes a plurality of encoder blocks that each include a self attention module, at least two adder modules, and a multi-layer perceptron (MLP) module.

In further features, the code, when executed by the one or more processors, performs to process the plurality of images, and (a) the depth maps for the plurality of images, and to input the depth maps for the plurality of images to encoders of the neural network.

In further features, each encoder includes a plurality of encoder blocks that each include a self attention module, at least two adder modules, and a multi-layer perceptron (MLP) module.

In further features, the code, when executed by the one or more processors, performs to process the plurality of images, and the relative pose, and to input the relative pose to decoders of the neural network.

In further features, each decoder includes a plurality of decoder blocks that each include a self attention module, at least three adder modules, a cross attention module, and a multi-layer perceptron (MLP) module.

In further features, the code, when executed by the one or more processors, further for a first and second images of the plurality of images performs to process the second image, and at least one of (a) the intrinsics of one of the one or more imaging devices, (b) the depth map for the second image, and (c) the relative pose, using the neural network, which produced a first and a second pointmaps corresponding to the first and second images, to produce a third pointmap of the scene that corresponds to the first and second images, where the third pointmap is a one-to-one mapping between pixels of one of the second image and three-dimensional points of the scene.

In various embodiments, optionally may mean the component being configured to use the referenced input in processing but not necessarily needing to use the referenced input in the processing. Optional may also apply to described functionality being optional.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an example system architecture in which the methods according to this disclosure may be performed;

FIG. 2 is a functional block diagram of an example control system of an autonomous machine;

FIG. 3 is a block diagram of elements of a first system embodiment for generating pointmaps aligned in a common coordinate frame for use with three dimensional reconstruction applications;

FIG. 4 is a block diagram of elements of a second system embodiment for generating pointmaps aligned in a common coordinate frame for use with three-dimensional reconstruction applications with elements common to the system embodiment shown in FIG. 3 and a global aligner module;

FIG. 5 is a general flow diagram of the method carried out by the systems shown in FIGS. 3 and 4;

FIG. 6 illustrates the relationship between images and pointmaps produced by the neural network shown in FIGS. 3 and 4;

FIG. 7 is a flow diagram of the method carried out by a first neural network architecture, DUSt3R, for generating pointmaps aligned in a common coordinate frame by the systems shown in FIGS. 3 and 4;

FIG. 8 is a block diagram of elements of a first neural network architecture, DUSt3R, for generating pointmaps aligned in a common coordinate frame by the systems shown in FIGS. 3 and 4;

FIG. 9 illustrates examples of reconstruction using the DUSt3R network shown in FIG. 10A;

FIG. 10A illustrates an overview of the DUSt3R network;

FIG. 10B is an example architecture of the DUSt3R network shown in FIG. 10A;

FIGS. 11A and 11B show reconstruction examples on two scenes never seen during training;

FIGS. 12 and 13 are examples of 3D reconstruction of an unseen MegaDepth scene from two images;

FIGS. 14 and 15 are two examples of 3D reconstruction from two images only of unseen scenes;

FIGS. 16A, 16B, 16C and 16D show four examples of 3D reconstructions from nearly opposite viewpoints;

FIG. 17 is a reconstruction example from four random frames of an indoor sequence;

FIG. 18 is a functional block diagram of an example extension of the DUSt3R network, which may be referred to as the MUSt3R network;

FIG. 19 includes a functional block diagram of example architecture of the decoder module;

FIG. 20 includes a functional block diagram illustrating an example of injection;

FIG. 21 is a functional block diagram of an example implementation of an extension of the DUSt3R network, which may be referred to as the Pow3R network;

FIG. 22 includes a functional block diagram of an example implementation of an encoder block of an encoder of the Pow3R network and an example implementation of a decoder block of a decoder of the Pow3R network;

FIG. 23 illustrates examples of reconstructions of a scene;

FIG. 24 is a functional block diagram of an example of a network which may be referred to as the S-MUSt3R network;

FIG. 25 includes a functional block diagram illustrating operation of the S-MUSt3R network;

FIG. 26 illustrates loop finding and additional segment creation for increasing accuracy; and

FIG. 27 includes 3D reconstructions generated using the S-MUSt3R network.

In the drawings, reference numbers may be reused to identify similar and/or identical elements.

### DETAILED DESCRIPTION

Images a scene can be taken from different points of view within the scene and capture different portions of the scene. Some cameras provide camera calibration information and some cameras capture pose at the time when an image is captured. Sometimes, however, camera calibration information and pose is not available. Without the camera calibration information and pose, collective use of the images of the scene is difficult.

Structure from Motion (SfM) is a technique that creates 3D models of an object or scene from a series of 2D images. SfM works by analyzing how points in the images shift relative to each other as the camera moves, using principles like motion parallax, to reconstruct the scene's 3D structure and the camera's position and orientation for each image. SfM may be used in robotics, augmented reality, and photogrammetry to create 3D models, maps, or models of landscapes and objects.

The present disclosure (which deviates from SfM) involves models for generating 3D reconstructions of a scene using images of the scene without camera calibration information and without poses of the camera(s) that captured the images. 3D reconstructions of a scene can be used for many different tasks. For example, robotic navigation and visual odometry may be made more successful and accurate via a 3D reconstruction of a scene.

For example, a model can process image pairs and regress three dimensional (3D) reconstructions for alignment in a common coordinate system. As the number of pairs increases, however, robust and fast optimization may become a concern.

The present disclosure first involves a model that processes more than two images and that is configured to handle a large number of input images. The model may include a multi-layer memory structure. The multi-layer memory use reduces computational complexity and allows the model to scale to reconstruction based on larger numbers of input images. The model can be used online (e.g., via images captured in real time) or offline (e.g., based on a set of images previously captured).

As the number of images input to the model increases, however, the memory needed increases. Memory use may approach its limits however with large numbers of input images. This may make 3D reconstruction of large numbers of images infeasible.

The present disclosure also involves an extension of the model and involves segmenting an input set of images into overlapping segments of the images. Each segment includes a portion of the images that is also included in at least one other segment. Thus, the segments can be described as being overlapping.

The overlapping segments are each input to the model, and a pointmap is generated for each segment. The pointmaps are aligned in a common coordinate frame and stitched together for 3D reconstruction of the scene. Looping and optimization may be performed to determine additional segments based on similarities between images of different segments. The looping and optimization may increase accuracy of the alignment and the stitching and may improve the resulting 3D reconstruction of the scene.

### Section A. 3D Reconstruction Methods

### Section A.1 System Architecture

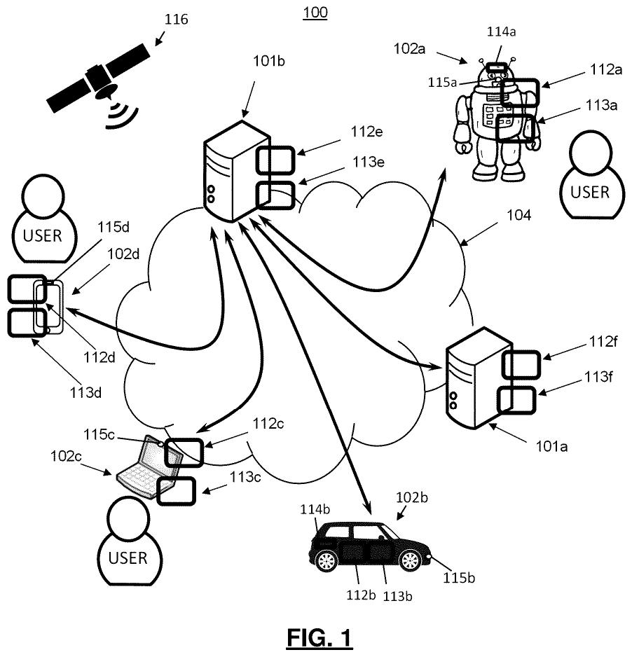

The disclosed systems and methods for generating 3D representations of scenes from a plurality of images may be implemented by a system 100 architected as illustrated in FIG. 1, which includes servers 101 and one or more computing devices 102 that communicate over a network 104 (which may be wireless and/or wired) such as the Internet for data exchange. Servers 101 and the computing devices 102 include one or more processors 112 and memory 113 such as a hard disk. The computing devices 102 may be any device that communicates with servers 101, including autonomous robot 102a, autonomous vehicle 102b, computer 102c, or cell phone 102d, which are equipped with an imaging device 115 for acquiring images of a scene (i.e., a device for acquiring images or video, such as cameras and cell phones). In one example, autonomous robot 102a and autonomous vehicle 102b are located using positioning system 114 communicating with geo-positioning system (GPS) 116, or, alternatively or in combination with, a cellular positioning system, an indoor positioning system (IPS), including beacons, RFID (radio frequency identifier), WiFi and geomagnetic, or a combination thereof.

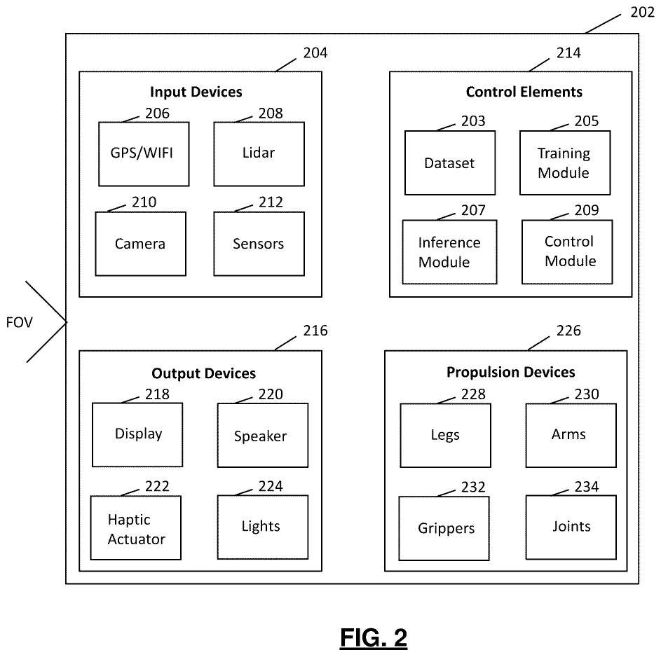

FIG. 2 is a functional block diagram of an example control system of an autonomous machine 202, such as autonomous robot 102a or autonomous vehicle 102b shown in FIG. 1. The autonomous machine 202, which may be mobile or stationary and indoor or outdoor, and may include one or more of the following elements: input devices 204 (e.g., GPS/WIFI 206, Lidar 208, camera 210 (which may include be grayscale, or red, green, blue (RGB) sensors for capturing images within a predetermined field of view (FOV), or which may update (capture images) at a predetermined frequency, such as 60 hertz (Hz), 120 Hz, or another suitable frequency), sensors 212 (e.g., temperature, rain, force, torque), control elements 214, output devices 216 (e.g., display 218, speakers 220, haptic actuator 222, lights 224), and propulsion devices (e.g., legs 228, arms 230, grippers 232, and joints 234).

In one example, the server 101b (with processors 112e and memory 113e) shown in FIG. 1 may include an inference module 207 and a control module 209 in memory 113e containing functionality for controlling autonomous machine 202, and the server 101a may include training module 205 and dataset 203 for training the policies of the inference module 207 (such as the neural networks 304 disclosed herein). In various implementations, the modules 207, 209, 205, and 203 may be implemented at least partially in memory 113 of the autonomous machine 202, or a combination thereof (e.g., modules 207 and 209 implemented in memory 113 of the autonomous machine 202 and modules 205 and 203 implemented in memory 113f on server 101a). In various implementations, the two servers 101a and 101b may be merged.

The autonomous machine 202 may be powered, such as via an internal battery and/or via an external power source, such as alternating current (AC) power. AC power may be received via an outlet, a direct connection, etc. In various implementations, the autonomous machine 202 may receive power wirelessly, such as inductively. In alternate embodiments, the autonomous machine 202 may include alternate propulsion devices 226, such as one or more wheels, one or more treads/tracks, one or more propellers, and/or one or more other types of devices configured to propel the autonomous machine 202 forward, backward, right, left, up, and/or down. In operation, the control module 209 actuates the propulsion device(s) 226 to perform tasks instructed by the inference module 207. In one example, speaker 220 receives a natural language description of a task that is input after being processed by an audio-to-text converter to inference module 207 that provides input to control module 209 to carry out the task.

### Section A.2 Overview & Nomenclature—Pointmaps, Cameras and Scenes

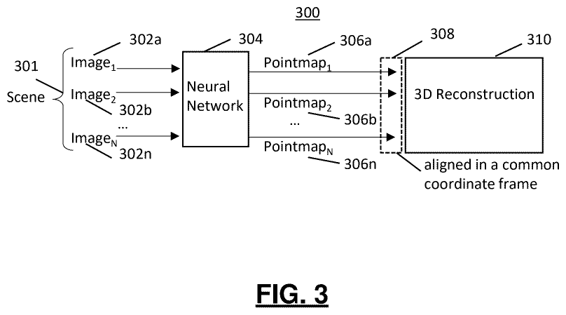

FIG. 3 is a block diagram of elements of a first example system 300 for generating a three dimensional reconstruction with a neural network 304, from images 302 of a scene 301, pointmaps 306 aligned in a common coordinate frame 308 for use with three-dimensional reconstruction module 310 to generate the three dimensional reconstruction. The images 302 may be acquired using one or more imaging devices (e.g., imaging device 115 shown in FIG. 1) from one or more viewpoints (points of view).

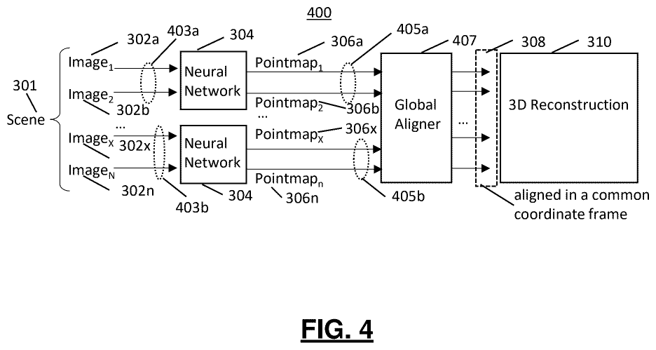

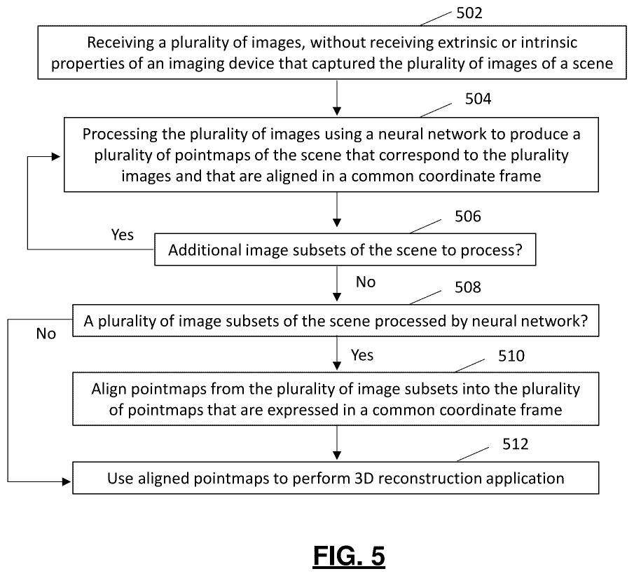

FIG. 4 is a block diagram of elements of a second example system 400 for generating a three dimensional reconstruction with a neural network 304, from images 302 of a scene 301, pointmaps 306 aligned in a common coordinate frame 308 for use with three-dimensional reconstruction module 310, with elements common to the system example shown in FIG. 3 and with a global aligner module 407. In various implementations, the global aligner module 407 may be omitted. FIG. 5 is a general flow diagram of the method carried out by the systems shown in FIGS. 3 and 4.

With reference to FIGS. 3, 4 and 5, images 302 of a scene 301 are received (at 502 in FIG. 5) and then processed by a neural network 304 thereby generating pointmaps 306 (at 504 in FIG. 5). When a single image 302 is available (i.e., the monocular case), the single image may be input multiple times to the neural network 304, which is in contrast when multiple images 302 are available (i.e., the multi-view case). As will be discussed in more detail below, the pointmaps 306 in the second system example shown in FIG. 4 may also be processed by a global aligner module 407 (at 510 in FIG. 5) to align the pointmaps 306 in a global coordinate system.

Once the pointmaps 306 in FIGS. 3 and 4 are aligned, they may be used by a three dimensional reconstruction module 310 to generate a three dimensional (3D) reconstruction (at 512 in FIG. 5) of the scene. Generating the 3D reconstruction may include (i) rendering a pointcloud of the scene for a given camera pose; (ii) recovering camera parameters of the scene; (iii) recovering depth maps of the scene for a given camera pose; and (iv) recovering three dimensional (colored, grayscale or monochrome) meshes of the scene. In one example, the inference module 207 embeds one of the systems 300 or 400 shown in FIGS. 3 and 4, respectively, that receives images from camera 210 and performs, using the 3D reconstruction module 310, visual localization in a scene using recovered camera parameters for the autonomous machine 202.

Advantageously, the neural network 304 and the scene generator 310 reconstruct from uncalibrated and unposed imaging devices, without prior information regarding the scene or the imaging devices, including extrinsic parameters (e.g., rotation and translation relative to some coordinate frame: (i) the absolute pose of the imaging device (i.e., the relation between the camera and a scene coordinate frame), (ii) relative pose of the different viewpoints of the scene (i.e., the relation between different camera poses)) and intrinsic parameters (e.g., camera lens focal length and distortion). The resulting scene representation is generated based on pointmaps 306 including properties that encapsulate (a) scene geometry, (b) relations between pixels and scene points and (c) relations between viewpoints. From aligned pointmaps 308 alone, scene parameters (i.e., cameras and scene geometry) may be recovered.

The neural network 304 uses an objective function that minimizes the error between ground-truth and predicted pointmaps 306 (after normalization) using a confidence score function. The neural network 304 in one example is based on or includes large language models (LLMs), which are large neural networks trained on large quantities of unlabeled data. The architecture of such neural networks may be based on a transformer architecture with a transformer encoder and decoder with a self-attention (SA) mechanism. Cross attention (CA) may also be included. An example transformer architecture as used in an embodiment herein is described in Ashish Vaswani et al., “Attention is all you need”, In I. Guyon et al., editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety. Alternative attention-based architectures include recurrent, graph and memory-augmented neural networks.

To apply the transformer network to images, the neural network 304 in an example herein is based on the Vision Transformer (ViT) architecture (see Alexey Dosovitskiy et al., entitled “An image is worth 16×16 words: Transformers for image recognition at scale”, in ICLR, 2021, which is incorporated herein in its entirety).

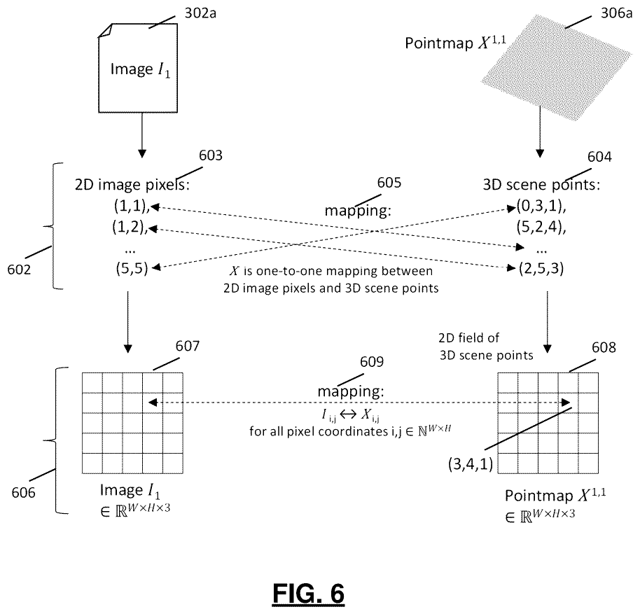

FIG. 6 illustrates the relationship between the pointmaps 306 produced by the neural network 304 from the images 302 shown in FIGS. 3 and 4 (at 504 in FIG. 5). Specifically in FIG. 6, the image 302a and corresponding pointmap 306a are shown. At 602, pointmap X 306a is illustrated generally; in association with its corresponding image I 302a of resolution W×H, pointmap X forms a one-to-one mapping 605 between 2D image pixels (e.g., RGB) 603 and 3D scene points (e.g., x, y, z) 604 (i.e., I_{i,j}↔X_{i,j} for all pixel coordinates i,j∈ [symbol] ^{W×H}).

At 606, one implementation of pointmap X is illustrated as a 2D field of 3D scene points 608, where mappings 609 for pointmap 306a are given by the position of the 2D field of 3D scene points 608 (i.e., a 5×5 matrix of 3D scene points) relative to the position of each pixel in the image 607 (i.e., a 5×5 matrix of 2D image pixels).

Further, examples disclosed herein may assume that each camera ray hits a single 3D point (i.e., the case of translucent surfaces may be ignored). In addition, given camera intrinsics K∈ [symbol] ^{3×3}, the pointmap X of the observed scene can be obtained from the ground-truth depthmap D∈ [symbol] ^{W×H} as X_{i,j}=K⁻¹ [iD_{i,j}, jD_{i,j}, D_{i,j}]^{T}, where i, j∈NW×H denote the x-y pixel coordinates. Here, X is expressed in the camera frame. Herein, X^{n,m} may denote the pointmap Xⁿ from camera n expressed in image m's coordinate frame: X^{n,m}=PₘPₙ⁻¹ h (Xⁿ) with Pₘ, Pₙ∈R^{3×4} the world-to-camera poses for views n and m, and h:(x, y, z)→(x, y, z, 1) the homogeneous mapping.

### Section A.3 DUSt3R: Dense Unconstrained Stereo 3D Reconstruction

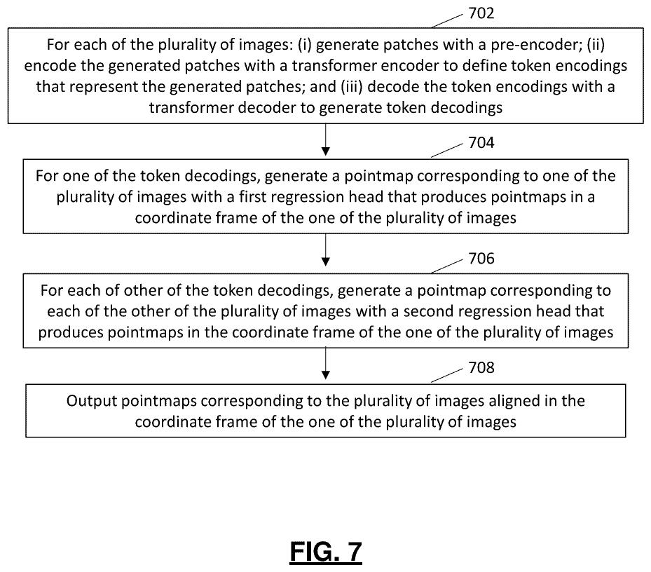

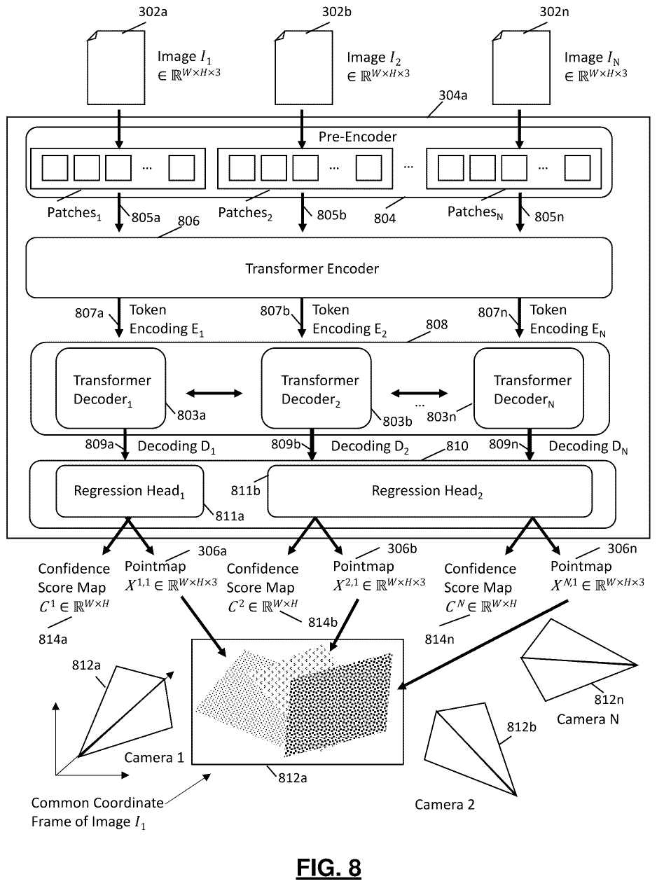

This Section sets forth a first example neural network architecture of the neural network 304 shown in FIGS. 3 and 4, which is also referred to herein as the DUSt3R (Dense Unconstrained Stereo 3D Reconstruction) architecture. FIG. 7A is a flow diagram of the method carried out by the example DUSt3R architecture and FIG. 8A is a block diagram of elements of the DUSt3R architecture, for generating pointmaps aligned in a common coordinate frame.

At 702, (i) for each of the plurality of images 302 {I₁, I₂, . . . , I_{N}} a pre-encoder (module) 804 generates patches 805; (ii) a transformer encoder (module) 806 encodes the patches 805 to generate token encodings 807 that represent the generated patches; and (iii) a transformer decoder (module) 808 decodes with decoder blocks 803 the token encodings 807, respectively, to generate token decodings 809 that are fed to regression head (module) 810. In the example of a network 304a adapted to process two input images 302 {I₁, I₂} (or more generally more than one image), after pre-encoder 804 generates patches, the transformer encoder 806 then reasons over both sets of patches jointly (collectively). In one example, the decoder is a transformer network including cross attention. Each decoder block 803 sequentially performs self-attention (each token of a view attends to tokens of the same view), then cross-attention (each token of a view attends to all other tokens of the other view). Information is shared between the branches during the decoder pass in order to output aligned pointmaps. Namely, each decoder block 803 attends to tokens encodings 807 from the other decoder block 803. Continuing with the example of two input images 302 {I₁, I₂} this may be given by:

$${G}_{i}^{1} = {DecoderBlock}_{i}^{1} ( {G}_{i - 1}^{1} , {G}_{i - 1}^{2} ) ,$$

$${G}_{i}^{2} = {DecoderBlock}_{i}^{2} ( {G}_{i - 1}^{2} , {G}_{i - 1}^{1} ) .$$

At 704, for one of the token decodings 809a, a pointmap 306a that corresponds to image 302a is generated by a first regression head 811a, which produces pointmaps in a coordinate frame 812a of the image 302a that is input to the regression head 811a. At 706, for each of the other token decodings 809b . . . 809n, pointmaps 306b . . . 306n that correspond to each of the other of the plurality of images 302b . . . 302n are generated by a second regression head 811b that produces pointmaps in the coordinate frame 812a (output by the first regression head 811a, not in the coordinate frames corresponding to the coordinate frames 812b . . . 812n, respectively, in which each image 302b . . . 302n was captured). More specifically, each branch is a separate regression head 811a and 811b which based on the set of decoder tokens D 809a and 809b . . . 809n generates at 708 pointmaps X 306a . . . 306n (in common reference frame 812a) and associated confidence maps C 814a . . . 814n, respectively. Returning to the example of two input images 302 {I₁, I₂} the regression head 810 may be given by:

$${X}^{1 , 1} , {C}^{1 , 1} = {Head}_{3 D}^{1} ( {G}_{0}^{1} , … , {G}_{B}^{1} ) ,$$

$${X}^{2 , 1} , {C}^{2 , 1} = {Head}_{3 D}^{2} ( {G}_{0}^{2} , … , {G}_{B}^{2} ) ,$$

where, G¹ and G² are the input tokens from the token decodings D 809 and X^{1,1}, C^{1,1} and X^{2,1}, C^{2,1} are pairs of pointmaps 306 and confidence maps 814, respectively.

The output pointmaps 306 are regressed up to a scale factor. Also, it should be noted that the DUSt3R architecture may not explicitly enforce any geometrical constraints. Hence, pointmaps 306 may not necessarily correspond to any physically plausible camera model. Rather during training, the DUSt3R neural network 304a may learn all relevant priors present from the training set, which only contains geometrically consistent pointmaps. Using a generic architecture leverages such training.

The DUSt3R neural network model may be trained in a fully-supervised manner using a regression loss, leveraging large public datasets for which ground-truth annotations are either synthetically generated, reconstructed from Structure-from-Motion (SfM) data, or captured using sensors. A fully data-driven strategy based on a transformer architecture may be used, not enforcing any geometric constraints at inference, but being able to benefit from powerful pretraining schemes. The DUSt3R neural network model learns strong geometric and shape priors, like shape from texture, shading or contours.

Additional details concerning the DUSt3R architecture described in this Section are set forth below, including training and experimentation.

### Section A.6 Global Alignment

With reference again to the example shown in FIG. 3 that uses a single neural network 304 to process a set of two or more (1 . . . M) input images 302, where M≥N, the total number of images 302 to be processed by neural network 304. In the event the total number of images N of the scene 301 to be processed exceeds M (the total number of images network 304 may process), the embodiment in FIG. 4 may be used to process subsets of images 403 (at 506 in FIG. 5). For example, assuming M=2 and N=2, given two views of a scene (I₁, I₂), the neural network 302 processes the two images and produces two pointmaps aligned in a common coordinate frame as shown in FIG. 3. At 508 a determination may be made whether a plurality of image subsets of the scene have been processed by the neural network 304.

In contrast, the embodiment shown in FIG. 4 uses neural network 304 at least twice. Assuming M=2 (the total number of images network 304 may process) and N=3 (the total number of images to be processed, i.e., there exists three views of a scene (I₁, I₂, I₃)), the neural network 304 processes a first subset 403a of two images (for example, I₁, I₂) and a second subset 403b of two images (for example, I₃, I₂), resulting in two sets of pointmaps at 405a and 405b in FIG. 4 (at 506 and 504 in FIG. 5). Assuming all subsets of images 403 have been processed at 506 in FIG. 5 (image pair I₁, I₃ could also be processed but it may not be necessary), a global coordinate frame alignment is performed by global aligner 407 (at 510 in FIG. 5) to align processed subsets 405 of pointmaps (e.g., to align in a common coordinate frame the subset of pointmaps 405a for image pairs I₁, I₂ with pointmaps that are aligned together in a first coordinate frame and the subset of pointmaps 405b for image pairs I₃, I₂ with pointmaps that are aligned together in a second common coordinate frame). Such processing at 510 enables the alignment of multiple subsets of pointmaps 405 predicted from multiple subsets of images 403 into a joint 3D space of aligned pointmaps 308 for a scene 301. This is possible because the content of the pointmaps 306 encompasses subsets of aligned point-clouds and their corresponding pixel-to-3D mappings as discussed with reference to FIG. 6.

Aligning subsets of pointmaps 405 of a scene 301 processed by global aligner (module) 407 in FIG. 4 (at 510 in FIG. 5) involves the construction of a connectivity graph. For example, given a set of images {I¹, I², . . . , I^{N}} for a given scene, a connectivity graph G(V, E) is constructed by the global aligner 407 where N images form vertices V and each edge e=(n,m)∈E indicates that images Iⁿ and I^{m} shares some visual content. In one embodiment, all image pairs are passed through network 304 and their overlap is measured based on the average confidence in both pairs, then low-confidence pairs are filtered out. In various implementations, image retrieval methods may be used to construct a connectivity graph.

After constructing a connectivity graph G, globally aligned pointmaps are recovered {Xn∈R^{W×H×3}} for all camera viewpoints n=1 . . . N that captured images of the scene, by predicting for each image pair e=(n,m)∈E, the pairwise pointmaps X^{n,n}, X^{m,n} and their associated confidence maps C^{n,n,}, C^{m,n}. More specifically, denoting X^{n,e}:X^{n,n} and X^{m,e}:=X^{m,n}, and since the goal involves rotating all pairwise predictions in a common frame, a pairwise pose Pₑ and scaling σ^{e}>0 associated with each edge e∈E are defined. Given the foregoing, the following optimization problem may be solved:

$${χ}^{*} = {arg min}_{χ , P , σ} {\sum }_{e ∈ ℰ} {\sum }_{v ∈ e} {\sum }_{i = 1}^{HW} {C}_{i}^{v , e} ‖ {χ}_{i}^{v} - {σ}_{e} {P}_{e} {X}_{i}^{v , e} ‖ .$$

Solving such global optimization may be carried out using gradient descent which in an example converges after a few hundred steps, involving seconds on a GPU (Graphics Processing Unit). The idea is that, for a given pair e=(n,m), the same rotation Pₑ should align both pointmaps X^{n,e} and X^{m,e} with the world-coordinate pointmaps _{X}n and _{X}m, since X^{n,e} and X^{m,e} are by definition both expressed in the same coordinate frame. To avoid the optimum where σₑ=0, ∀e∈E, Πₑ σₑ=1 may be enforced. An extension to this framework enables the recovery of all cameras parameters: by replacing _{X}n:=Pₙ⁻¹ h(Kₙ⁻¹[U Dₙ; V Dₙ; Dₙ]), all camera poses {Pₙ}, associated intrinsics {Kₙ} and depthmaps {Dₙ} for n=1 . . . N may be estimated.

### Section A.7 Review

Generally speaking, the neural networks disclosed herein are configured to reconstruct a 3D scene from un-calibrated and un-posed images of the scene by unifying monocular and binocular 3D reconstruction. The pointmap representation for Multi-View Stereo (MVS) applications enables the neural network to predict 3D shapes in a canonical frame, while preserving implicit relationship between pixels and the scene. This effectively drops many constraints of the usual perspective camera formulation. Further, an optimization procedure may be used to globally align pointmaps in the context of multi-view 3D reconstruction by optimizing the camera pose and geometry alignment directly in 3D space. This procedure can extract intermediary outputs of existing Structure-from-Motion (SfM) and MVS pipelines. Finally, the neural networks disclosed herein are configured to handle real-life monocular and multi-view reconstruction scenarios seamlessly, even when the camera is not moving between frames.

In addition to methods set forth for generating 3D representations of scenes from a plurality of images, the present application includes a computer program product comprising code instructions to execute the methods described herein (e.g., data processors 112 of the servers 101 and the computing devices 102), and storage readable by computer equipment (memory 113) provided with this computer program product for storing such code instructions.

### Section B. DUSt3R: Dense Unconstrained Stereo 3D Reconstruction

Multi-view stereo reconstruction (MVS) in the wild involves estimating by one or more processors the camera parameters (e.g., intrinsic and extrinsic parameters). These may be tedious and cumbersome to obtain, yet they are used to triangulate corresponding pixels in 3D space, which may be important. In this application, an alternative stance is taken and DUSt3R is introduced, a novel paradigm for Dense and Unconstrained Stereo 3D Reconstruction (DUSt3R) of arbitrary image collections (operating without prior information about camera calibration nor viewpoint poses). The pairwise reconstruction problem is cast as a regression of pointmaps, relaxing the hard constraints of projective camera models. This present application shows that this formulation smoothly unifies the monocular and binocular reconstruction cases. In the case where more than two images are provided, this application proposes a simple yet effective global alignment strategy that expresses all pairwise pointmaps in a common reference frame. The disclosed network architecture is based on transformer encoders and decoders, which allows powerful pretrained models to be leveraged. The disclosed formulation directly provides a 3D model of the scene as well as depth information, but interestingly, pixel matches, relative and absolute cameras can be seamlessly recovered from it. Experiments on all these tasks showcase that DUSt3R can unify various 3D vision tasks and set high performance on monocular/multi-view depth estimation as well as relative pose estimation. Advantageously, DUSt3R makes many geometric 3D vision tasks easy to perform.

### Section B.1 Introduction

Unconstrained image-based dense 3D reconstruction from multiple views is useful for computer vision. Generally speaking, the task may involve estimating the 3D geometry and camera parameters of a scene, given a set of images of the scene. Not only does it have numerous applications/tasks like mapping, navigation, archaeology, cultural heritage preservation, robotics, but perhaps more importantly, it holds a fundamentally special place among all 3D vision tasks. Indeed, it may subsume nearly all of the other geometric 3D vision tasks. Thus, some approaches for 3D reconstruction include keypoint detection and matching, robust estimation, Structure-from-Motion (SfM) and Bundle Adjustment (BA), dense Multi-View Stereo (MVS), etc.

SfM and MVS pipelines may involve solving a series of minimal problems: matching points, finding matrices, triangulating points, sparsely reconstructing the scene, estimating cameras and finally performing dense reconstruction of the scene. This rather complex chain may be a viable solution in some settings, but may be unsatisfactory in others: each sub-problem may not be solved perfectly and adds noise to the next sub-problem, increasing the complexity and the engineering effort for the pipeline to work as a whole. In this regard, the absence of communication between each sub-problem may be telling: it would seem more reasonable if they helped each other, i.e., dense reconstruction may benefit from the sparse scene that was built to recover camera poses, and vice-versa. In addition, functions in this pipeline may be brittle. For instance, a stage of SfM that serves to estimate all camera parameters, may fail in situations, e.g., when the number of scene views is low, for objects with non-Lambertian surfaces, in case of insufficient camera motion, etc.

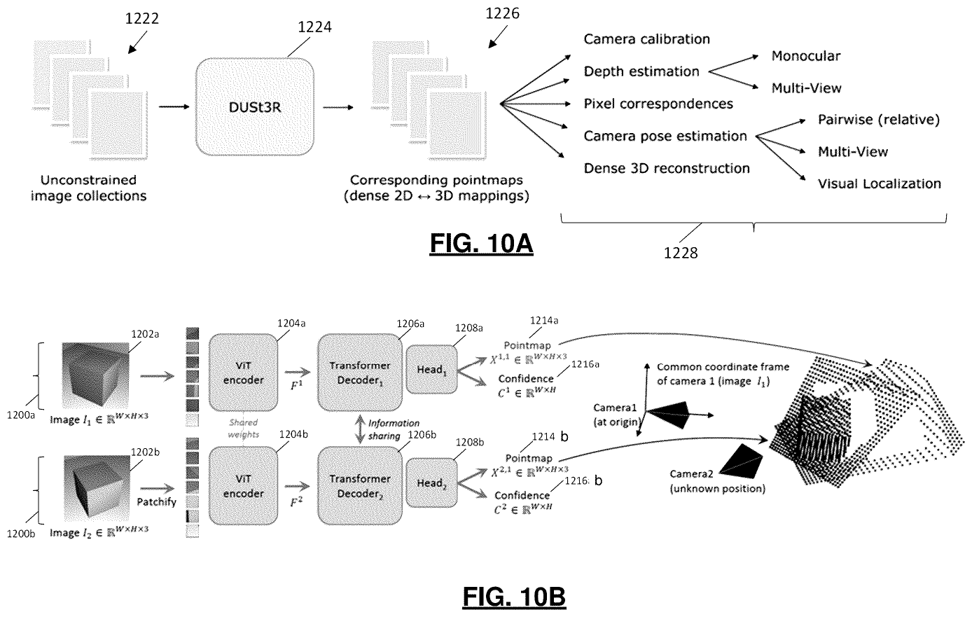

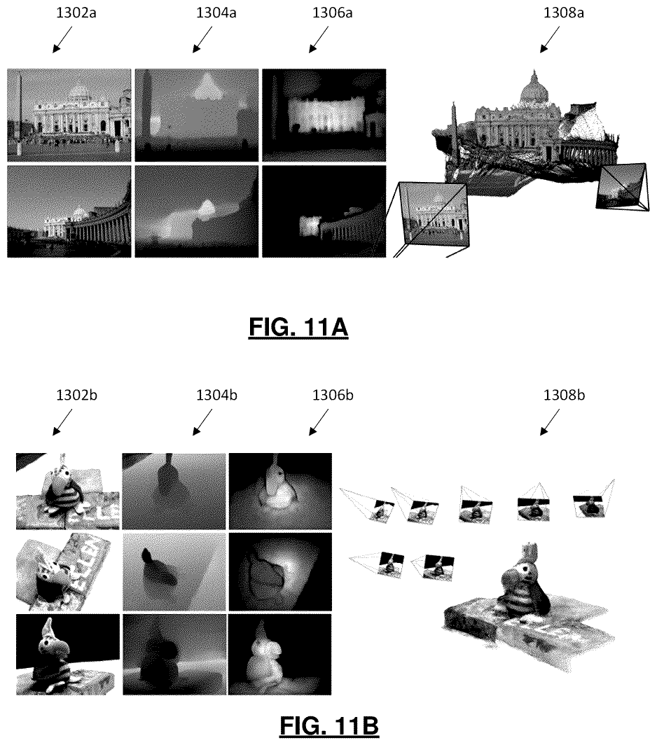

In this Section B, DUSt3R, a novel approach for Dense Unconstrained Stereo 3D Reconstruction from un-calibrated and un-posed cameras, is discussed. FIG. 10A illustrates that given a set of photographs 1222 with unknown camera poses and intrinsics, the proposed DUSt3R network 1224 outputs a set of corresponding pointmaps 1226, from which can be recovered a variety of geometric quantities 1228 normally difficult to estimate all at once, such as the camera parameters, pixel correspondences, depthmaps, and fully consistent 3D reconstruction. The DUSt3R network 1224 also works for a single input image (e.g., achieving in this case monocular reconstruction).

A component is a network that can regress a dense and accurate scene representation solely from a pair of images, without prior information regarding the scene nor the cameras (not even the intrinsic parameters). The resulting scene representation is based on 3D pointmaps with rich properties: they simultaneously encapsulate (a) the scene geometry, (b) the relation between pixels and scene points and (c) the relation between the two viewpoints. From this output alone, practically all scene parameters (e.g., cameras and scene geometry) can be extracted. This is possible because the disclosed systems and methods jointly processes the input images and the resulting 3D pointmaps, thus learning to associate 2D structures with 3D shapes, and having the opportunities of solving multiple minimal problems simultaneously, enabling internal collaboration between them.

As set forth above, the disclosed examples may be trained in a fully-supervised manner using a regression loss, leveraging large public datasets for which ground-truth annotations are either synthetically generated, reconstructed from SfM software or captured using dedicated sensors). The disclosed examples are different from integrating task-specific modules, and instead adopt a fully data-driven strategy based on a transformer architecture, not enforcing any geometric constraints at inference, but being able to benefit from powerful pretraining schemes. The networks learns strong geometric and shape priors, like shape from texture, shading or contours.

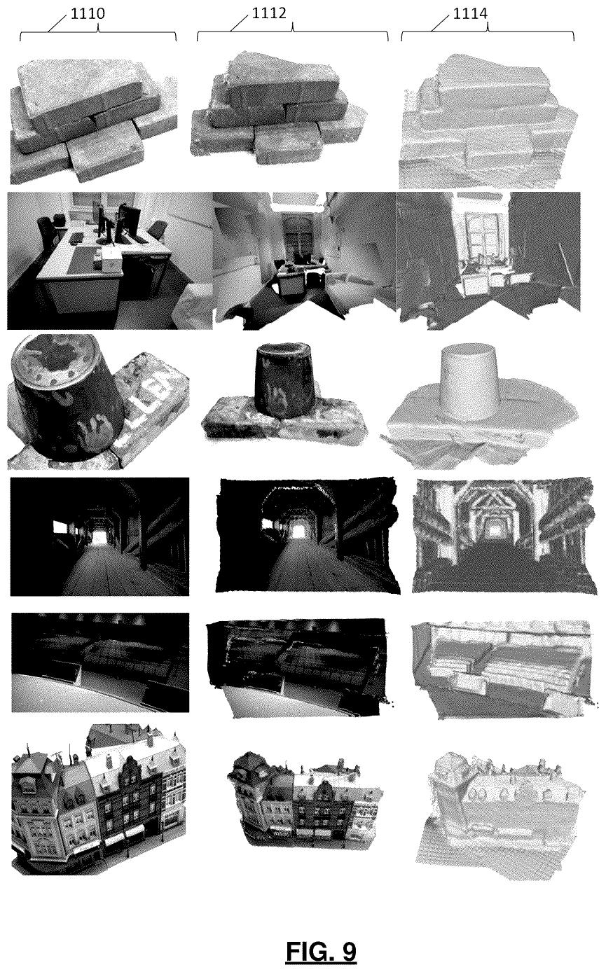

To fuse predictions from multiple images pairs, bundle adjustment (BA) for the case of pointmaps may be used, thereby achieving full-scale MVS. Some of the disclosed embodiments introduce a global alignment procedure that, contrary to BA, does not involve minimizing reprojection errors. Instead, the camera pose and geometry alignment directly in 3D space are optimized, which is fast and shows excellent convergence in practice. Experiments show that the reconstructions are accurate and consistent between views in real-life scenarios with various unknown sensors. The disclosed embodiments further demonstrate that the same architecture can handle real-life monocular and multi-view reconstruction scenarios seamlessly. Examples of reconstructions using the DUSt3R network shown in FIG. 10A are shown in FIG. 9. More specifically, FIG. 9 shows qualitative examples using samples from the DTU dataset (see Aanæs et al., “Large-Scale Data for Multiple-View Stereopsis” in IJCV, 2016), Tanks and Temples (see Knapitsch et al., “Tanks and temples: Benchmarking large-scale scene reconstruction”, in ACM Transactions on Graphics, 36(4), 2017) and ETH-3D (see Schops et al., “A Multi-View Stereo Benchmark with High-Resolution Images and Multi-Camera Videos”, CVPR, 2017) datasets obtained without camera parameters; for each sample there is shown: an input image 1110, a point cloud 1112, and a rendered (with shading for a better) view of the underlying geometry 1114.

The disclosed contributions are at least fourfold. First, the first holistic end-to-end 3D reconstruction pipeline from un-calibrated and un-posed images is presented that unifies monocular and binocular 3D reconstruction. Second, the pointmap representation for MVS applications is introduced that enables the network to predict the 3D shape in a canonical frame, while preserving the implicit relationship between pixels and the scene. This effectively drops many constraints of perspective camera formulations. Third, an optimization procedure to globally align pointmaps in the context of multi-view 3D reconstruction is introduced. The disclosed procedure can extract effortlessly all usual intermediary outputs of the classical SfM and MVS pipelines. The disclosed approaches unify 3D vision tasks and considerably simplify other reconstruction pipelines, making DUSt3R seem simple and easy in comparison. Fourth, promising performance is demonstrated on a range of 3D vision tasks, such as multi-view camera pose estimation.

### Section B.2 Related Information

Some related information on 3D vision are summarized in this Section.

Structure-from-Motion (SfM) involves reconstructing sparse 3D maps while jointly determining camera parameters from a set of images. Some pipelines starts from pixel correspondences obtained from keypoint matching between multiple images to determine geometric relationships, followed by bundle adjustment to optimize 3D coordinates and camera parameters jointly. Learning-based techniques may be incorporated into subprocesses. The sequential structure of the SfM pipelines persist however, making it vulnerable to noise and errors in each individual component.

MultiView Stereo (MVS) involves the task of densely reconstructing visible surfaces, which is achieved via triangulation between multiple viewpoints. In a formulation of MVS, all camera parameters may be provided as inputs. Approaches may depend on camera parameter estimates obtained via calibration procedures, either during the data acquisition or using Structure-from-Motion approaches for in-the-wild reconstructions. In real-life scenarios, inaccuracy of pre-estimated camera parameters can be detrimental for proper performance. This present application proposes instead to directly predict the geometry of visible surfaces without any explicit knowledge of the camera parameters.

Direct RGB-to-3D. Some approaches may directly predict 3D geometry from a single RGB image. Neural networks that learn strong 3D priors from large datasets to solve ambiguities may be leveraged. These methods can be classified into two groups. A first group leverages class-level object priors. For instance, learning a model that can fully recover shape, pose, and appearance from a single image, given a large collection of 2D images may be used. A second group may involve general scenes. Systematically built may be monocular depth estimation (MDE) networks. Depth maps encode a form of 3D information and, combined with camera intrinsics, can yield pixel-aligned 3D point-clouds. SynSin (see Wiles et al., “SynSin: End-to-end view synthesis from a single image”, in CVPR, pp. 7465-7475, 2020), for example, performs new viewpoint synthesis from a single image by rendering feature-augmented depthmaps knowing all camera parameters. Without camera intrinsics, they can be inferred by exploiting temporal consistency in video frames, either by enforcing a global alignment or by leveraging differentiable rendering with a photometric reconstruction loss. Another way is to explicitly learn to predict camera intrinsics, which enables performing metric 3D reconstruction from a single image when combined with MDE networks. These methods are, however, intrinsically limited by the quality of depth estimates, which is poorly suited for monocular settings.

The proposed systems and methods process two viewpoints simultaneously in order to output depthmaps, or rather, pointmaps. This makes triangulation between rays from different viewpoint possible. The disclosed systems and methods output pointmaps (i.e., dense 2D field of 3D points), which handle camera poses implicitly and makes the regression problem better posed.

Pointmaps. Using a collection of pointmaps as shape representation may be counter-intuitive for MVS.

### Section B.3 Method

Before discussing the details of a disclosed example method, this section introduces some concepts of pointmaps also discussed above.

Pointmap. In the following, a dense 2D field of 3D points may be denoted as a pointmap X∈ [symbol] ^{W×H×3}. In association with its corresponding RGB image I of resolution W×H, X forms a one-to-one mapping between image pixels and 3D scene points, i.e., I_{i,j}↔X_{i,j}, for all pixel coordinates (i, j)∈{1 . . . W}×{1 . . . H}. The disclosed embodiments assume that each camera ray (e.g., from a center of the camera) hits a single 3D point (i.e., ignoring the case of translucent surfaces).

Camera and scene. Given the camera intrinsics K∈ [symbol] ^{3×3}, the pointmap X of the observed scene can be obtained by one or more processors from the ground-truth depthmap D∈ [symbol] ^{W×H} as X_{i,j}=K⁻¹[iD_{i,j}jD_{i,j}, D_{i,j}]^{T}. Here, X is expressed in the camera coordinate frame. In the following, X^{n,m} is denoted as the pointmap Xⁿ from camera n expressed in camera m's coordinate frame:

$${X}^{n , m} = {P}_{m} {P}_{n}^{- 1} h ( {X}^{n} ) \qquad ( B1 )$$

with Pₘ, Pₙ∈ [symbol] ^{3×4} the world-to-camera poses for images n and m, and h:(x, y, z)→(x, y, z, 1) the homogeneous mapping.

### Section B.3.1 Overview

The disclosed embodiments describe a network that solves the 3D reconstruction task for the generalized stereo (multiple image) case through direct regression. To that aim, a network [symbol] is trained that takes as input at least 2 RGB images I¹, I²∈ [symbol] ^{W×H×3} and generates at least 2 corresponding pointmaps X^{1,1}, X^{2,1}∈ [symbol] ^{W×H×3} with associated confidence maps C^{1,1}, C^{2,1}∈ [symbol] ^{W×H} based on the respective RGB images. Both pointmaps are expressed in the same coordinate frame of I¹, which offers advantages as described herein. For the sake of clarity and without loss of generality, both images are assumed to have the same resolution W×H, but in practice their resolution can differ.

Network architecture. FIG. 10B illustrates an example architecture of the DUSt3R network shown in FIG. 10A. The architecture of the disclosed network [symbol] 1204 may benefit from CroCo pretraining. Details on the Cross-view Completion “CroCo” architecture and pretraining is set forth in Weinzaepfel et al., (i) “CroCo: Self-Supervised Pre-Training for 3D Vision Tasks by Cross-View Completion”, in NeurIPS, 2022 and (ii) “CroCo v2: Improved Cross-view Completion Pre-training for Stereo Matching and Optical Flow”, in ICCV, 2023 ((i) and (ii) also referred to herein as “Weinzaepfel et al. 2023”), and in (iii) U.S. patent application Ser. Nos. 18/230,414 and 18/239,739, each of which is incorporated herein in its entirety. The resulting token representations F¹ and F² of networks 1204a and 1204b, respectively, are passed to two transformer decoders 1206 that constantly exchange information via cross-attention and finally, two regression heads 1208 output the two corresponding pointmaps 1214 and associated confidence maps 1216. The two pointmaps 1214a and 1214b may be expressed in the same coordinate frame of the first image I¹, and the network F is trained using a simple regression loss.

More specifically, as shown in FIG. 10B, an architecture of the DUSt3R network shown in FIG. 10A include two (e.g., identical) branches 1200a and 1200b (one for each image 1202) comprising each an image encoder 1204, a decoder 1206 and a regression head 1208 (1208a and 1208b). The two input images 1202 are first encoded in a Siamese manner by the same weight-sharing ViT encoder 1204 (see Dosovitskiy et al.), yielding two token representations F¹ and F²:

$${F}^{1} = Encoder ( {I}^{1} ) , {F}^{2} = Encoder ( {I}^{2} ) .$$

The network reasons over both token representations jointly in the decoder 1206. Similarly to CroCo, the decoder 1206 may be a transformer network equipped with cross attention. Each decoder block 1206 sequentially performs self-attention (each token of a view attends to tokens of the same view), then cross-attention (each token of a view attends to all other tokens of the other view), and finally feeds tokens to regression head 1208, such as a Multi-Layer Perceptron (MLP). Importantly, information is constantly shared between the two branches during the decoder pass/operation 1206. This is to output properly aligned pointmaps. Namely, each decoder block 1206 attends to tokens from the other branch, such as follows:

$${G}_{i}^{1} = {DecoderBlock}_{i}^{1} ( {G}_{i - 1}^{1} , G\_ {( i - 1 )}^{⋀} 2 )$$

$${G}_{i}^{2} = {DecoderBlock}_{i}^{2} ( {G}_{i - 1}^{2} , G\_ {( i - 1 )}^{⋀} 1 )$$

for i=1, . . . , B for a decoder with B blocks and initialized with encoder tokens

$${G}_{0}^{1} := {F}^{1} and$$

$${G}_{0}^{2} := {F}^{2} .$$

### Here, DecoderBlock

$$\begin{matrix}v \\ i\end{matrix} ( {G}^{1} , {G}^{2} )$$

denotes the i-th block in branch v∈{1,2}, G¹ and G² are the input tokens, with G² the tokens from the other branch. Finally, in each branch a separate regression head 1208 takes the set of decoder tokens and outputs a pointmap and an associated confidence map:

$${X}^{1 , 1} , {C}^{1 , 1} = {Head}^{1} ( {G}_{0}^{1} , … , {G}_{B}^{1} ) ,$$

$${X}^{2 , 1} , {C}^{2 , 1} = {Head}^{2} ( {G}_{0}^{2} , … , {G}_{B}^{2} ) ,$$

where X^{1,1} and X^{2,1} are output pointmaps and C^{1,1} and C^{2,1} are output confidence score maps.

The output pointmaps X^{1,1} and X^{2,1} are regressed up to a scale factor, such as by the regression heads. The disclosed architecture may not explicitly enforce any geometrical constraints. Hence, pointmaps may not necessarily correspond to any physically plausible camera model. Rather, the network can learn all relevant priors present from the training set, which only includes geometrically consistent pointmaps. Using the described architecture allows leveraging strong pretraining technique, ultimately surpassing what task-specific architectures can achieve. The learning process is detailed in the next section.

### Section B.3.2 Training/Learning Objective

3D Regression loss. An objective of training of the network is based on regression in the 3D space. The ground truth pointmaps are denoted as X̅^{1,1} and X̅^{2,1}, obtained from Equation B1 along with two corresponding sets of valid pixels D¹, D²⊆{1 . . . W}×{1 . . . H} on which the ground-truth is defined. The regression loss for a valid pixel i∈D^{v} in view v∈{1, 2} may be defined as the Euclidean distance:

$${ℓ}_{regr} ( v , i ) = ‖ \frac{1}{z} {X}_{i}^{v , 1} - \frac{1}{\overline{z}} {\overline{X}}_{i}^{v , 1} ‖ \qquad ( B2 )$$

To handle the scale ambiguity between prediction and ground-truth, the predicted and ground-truth pointmaps may be normalized (e.g., by a normalization module) by scaling factors z=norm(X^{1,1}, X^{2,1}) and z̅=norm(X̅^{1,1}, X̅^{2,1}), respectively, which represent the average distance of all valid points to the origin:

$$norm ( {X}^{1} , {X}^{2} ) = \frac{1}{\vert D 1 \vert + \vert D 2 \vert} {\sum }_{v ∈ \{ 1 , 2 \}} {\sum }_{i ∈ {D}^{v}} ‖ {X}_{i}^{v} ‖ \qquad ( B3 )$$

Confidence-aware loss. In reality, there may be ill-defined 3D points, e.g., in the sky or on translucent objects. More generally, some parts in the image may be harder to predict that others. The disclosed examples jointly learn to predict a score for each pixel which represents the confidence that the network has about this particular pixel. A training objective may be training the network based on (e.g., minimizing) the confidence-weighted regression loss from Equation B2 over all valid pixels:

$${ℒ}_{conf} = {\sum }_{v ∈ \{ 1 , 2 \}} {\sum }_{i ∈ {D}^{v}} {C}_{i}^{v , 1} {l}_{regr} ( v , i ) - α log {C}_{i}^{v , 1} , \qquad ( B4 )$$

where

$${C}_{i}^{v , 1}$$

is the confidence score for pixel i, and α is a hyper-parameter controlling the regularization term (see Wan et al., “Confnet: Predict with confidence”, in ICASSP, pp. 2921-2925, 2018, which is incorporated herein in its entirety). To ensure a strictly positive confidence, define

$${C}_{i}^{v , 1} = 1 + exp \text{?} > 1.$$

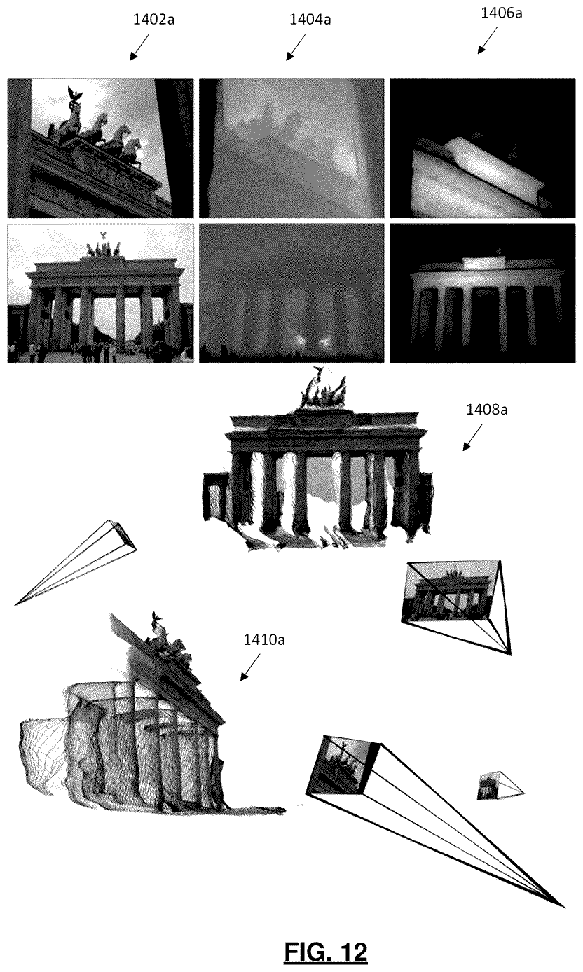

This has the effect of forcing the network to extrapolate in harder areas, e.g., like those ones covered by a single view. Training network F with this objective allows to estimate confidence scores without explicit supervision. Examples of input image pairs with their corresponding outputs are shown in FIGS. 11A and 11B. More specifically, FIGS. 11A and 11B show reconstruction examples on two scenes never seen during training, with from left to right: RGB 1302, depth map 1304, confidence map 1306 and reconstruction 1308; the scene in FIG. 11A shows the raw result output from F(I1, I2) and the scene in FIG. 13B shows the outcome of global alignment discussed in Section B.3.4.

### Section B.3.3 Downstream Applications

The rich properties of the output pointmaps allows various convenient operations/tasks to be performed using the pointmaps.

Establishing correspondences between pixels of two images can be achieved using nearest neighbor (NN) search in the 3D pointmap space. To minimize errors, retaining of reciprocal (mutual) correspondences M_{1,2} between images I¹ and I² may be performed, i.e., providing:

$$\text{?} M\_ 1 , 2 = \{ ( i , j ) \vert i = NN \text{?} \_ {1}^{⋀} 1 , 2 ( j ) and j = \text{?} N N \text{?} \_ {1}^{⋀} 2 , 1 ( i ) \}$$

$$with {NN}_{k}^{n , m} ( i ) = {arg min}_{j ∈ \{ 0 , … , WH \}} \text{?} \vert \vert \text{?} {X}_{j}^{n , k} - {X}_{i}^{m , k} \vert \vert .$$

The pointmap X^{1,1} is expressed in image I¹'s coordinate frame. It is therefore possible to estimate the camera intrinsic parameters by solving an optimization problem based on the pointmap. In this application, it may be assumed that the principal point is approximately centered and pixel are squares, hence only the focal length

$${f}_{1}^{*}$$

remains to be estimated:

$${f}_{1}^{*} = {arg min}_{{f}_{1}} {\sum }_{i = 0}^{W} {\sum }_{j = 0}^{H} {C}_{i , j}^{1 , 1} ‖ ( {i}^{′} , {j}^{′} ) - {f}_{1} \frac{( {X}_{i , j , 0}^{1 , 1} , {X}_{i , j , 1}^{1 , 1} )}{{X}_{i , j , 2}^{1 , 1}} ‖ , \qquad ( B5 )$$

with

$${i}^{′} = i - \frac{W}{2} and {j}^{′} = j - \frac{H}{2} .$$

Fast iterative solvers, e.g., based on the Weiszfeld algorithm (see Frank Plastria, “The Weiszfeld Algorithm: Proof, Amendments, and Extensions” in Foundations of Location Analysis, pp. 357-389, Springer, 2011, which is incorporated herein in its entirety), can be used to find the focal length

$${f}_{1}^{*}$$

in a few iterations. For the focal length

$${f}_{2}^{*}$$

of the second camera, an option is to perform the inference for the image pair (I², I¹) and use Equation B5 with pointmap X^{2,2} instead of pointmap X^{1,1}.

Relative pose estimation can be achieved in several ways. One way is to perform 2D matching and recover intrinsics as described above, then estimate the Epipolar matrix and recover the relative pose. Another, more direct, way is to compare the pointmaps X^{1,1}↔X^{1,2} (or, equivalently, X^{2,2}↔X^{1,2}) using Procrustes alignment (see Luo et al., “Procrustes alignment with the EM algorithm”, in CAIP, vol. 1689 of Lecture Notes in Computer Science, pp. 623-631, Springer, 1999, which is incorporated herein in its entirety) to determine the relative pose P*=[R*|t*]:

$${R}^{*} , {t}^{*} = {arg min}_{σ , R , t} {\sum }_{i} {C}_{i}^{1 , 1} {C}_{i}^{1 , 2} {‖ σ ( R {X}_{i}^{1 , 1} + t ) - {X}_{i}^{1 , 2} ‖}^{2} ,$$

which can be achieved in closed-form. Procrustes alignment may be sensitive to noise and outliers. Another solution is to use RANSAC (Random Sample Consensus) with PnP (Perspective-n-Point), i.e., PnP-RANSAC (see Fischler et al., “Random Sample Consensus: A Paradigm for Model Fitting with Applications to Image Analysis and Automated Cartography”, in Commun. ACM 24(6):381-95, 1981 and Lepetit et al., “EPnP: An accurate O(n) solution to the PnP problem”, in IJCV, 2009, which is incorporated herein in its entirety).

Absolute pose estimation, which may also be referred to as visual localization, can likewise be achieved in several different ways. Let I^{Q} denote the query image and I^{B} the reference image for which 2D to 3D correspondences are available. First, intrinsics for I^{Q} can be estimated from pointmap X^{Q,Q} as discussed above. One solution includes obtaining 2D correspondences between I^{Q} and I^{B}, which in turn yields 2D-3D correspondences for I^{Q}, and then running PnP-RANSAC. Another solution is to determine the relative pose between I^{Q} and I^{B} as described previously. Then, this pose is converted to world coordinates by scaling it appropriately, according to the scale between X^{B,B} and the ground-truth pointmap for I^{B}. A pose module may determine pose as described herein.

### Section B.3.4 Global Alignment

The network [symbol] presented so far in this Section B.3 can handle a pair of images. Presented now is a fast and simple post-processing optimization for entire scenes that enables the alignment of pointmaps predicted from multiple (e.g., more than two) images into a joint 3D space (i.e., global aligner 407 shown in FIG. 4). This is possible due to the rich content of the disclosed pointmaps, which encompasses by design two aligned point-clouds and their corresponding pixel-to-3D mapping.

Pairwise graph. Given a set of images {I¹, I², . . . , I^{N}} for a given scene, first a connectivity graph G(V, E) is generated where N images form vertices V and each edge e=(n,m)∈E indicates that images Iⁿ and I^{m} shares some visual content. To that aim, either an image retrieval method is used, or all pairs are passed through network F and their overlap is measured based on the average confidence in both pairs, then out low-confidence pairs are filtered out.

Global optimization. The disclosed embodiments use the connectivity graph G to recover globally aligned pointmaps {χⁿ∈ [symbol] ^{W×H×3}} for all cameras n=1 . . . N. To that aim, first predict, for each image pair e=(n,m)∈E, the pairwise pointmaps X^{n,n}, X^{m,n} and their associated confidence maps C^{n,n}, C^{m,n}. For the sake of clarity, let the following be defined as: X^{n,e}:=X^{n,n} and X^{m,e}:=X^{m,n}. Since the disclosed goal involves rotating all pairwise predictions in a common coordinate frame, a pairwise pose Pₑ∈R^{3×4} and scaling σₑ>0 associated to each pair e∈E is introduced. Then the following optimization problem may be formulated:

$${χ}^{*} = {arg min}_{X , P , σ} {\sum }_{e ∈ E} {\sum }_{v ∈ e} {\sum }_{i = 1}^{W H} {C}_{i}^{v , e} ‖ {χ}_{i}^{v} - {σ}_{e} {P}_{e} {X}_{i}^{v , e} ‖ . \qquad ( B6 )$$

where v∈e for v∈{n,m} if e=(n,m). For a given image pair e, the same rigid transformation Pₑ should align both pointmaps χ^{n,e} and χ^{m,e} with the world-coordinate pointmaps χⁿ and χ^{m}, since χ^{n,e} and χ^{m,e} are by definition both expressed in the same coordinate frame. To avoid the trivial optimum where σₑ=0, ∀e∈E, Πₑ σe=1 is enforced.

Recovering camera parameters. An extension to this framework enables the recovery of all cameras parameters. By replacing X_(i,j)\hat{ }n:=P_n\hat{ }(−1)h(K_n\hat{ }(−1)[iD_(i,j)\hat{ }n; [symbol] jD [symbol] _(i,j)\hat{ }n; D_(i,j)\hat{ }n] (i.e., enforcing a standard camera pinhole model as in Equation B1), all camera poses {Pₙ}, associated intrinsics {Kₙ} and depthmaps {Dₙ} for n=1 . . . N can be estimated.

Discussion Different than bundle adjustment, global optimization embodiments are fast and simple to perform. The disclosed examples are not minimizing 2D reprojection errors, as in bundle adjustment, but 3D projection errors. The optimization may be carried out by an optimization module using gradient descent and typically converges after a few hundred steps, requiring mere seconds on a standard GPU.

### Section B.4 Experiments with DUSt3R

Training data. In one embodiment, the disclosed network is trained with a mixture of eight datasets: Habitat (see Savva et al., “Habitat: A Platform for Embodied AI Research” in ICCV, 2019), MegaDepth (see Li et al., “Megadepth: Learning single-view depth prediction from internet photos”, in CVPR, pp. 2041-2050, 2018), ARKitScenes (see Dehghan et al., “ARKitScenes: A diverse real-world dataset for 3d indoor scene understanding using mobile RGB-D data”, in NeurIPS Datasets and Benchmarks, 2021, MegaDepth, Static Scenes 3D (see Mayer et al., “A Large Dataset to Train Convolutional Networks for Disparity, Optical Flow, and Scene Flow Estimation”, in CVPR, 2016), Blended MVS (Yao et al., “Blended MVS: A Large-Scale Dataset for Generalized Multi-View Stereo Networks”, in CVPR, 2020), ScanNet++ (see Yeshwanth et al., “ScanNet++: A high-fidelity dataset of 3d in-door scenes”, in ICCV 2023), CO3Dv2 (see Reizenstein et al., “Common Objects in 3D: Large-Scale Learning and Evaluation of Real-Life 3D Category Reconstruction”, in ICCV, 2021), and Waymo (see Sun et al., “Scalability in Perception for Autonomous Driving: Waymo Open Dataset”, in CVPR, 2020). These datasets feature diverse scenes types: indoor, outdoor, synthetic, real-world, object-centric, etc. When image pairs are not directly provided with the dataset, they are extracted based on the CroCo method. Specifically, image retrieval and point matching algorithms may be utilized to match and verify image pairs. In one embodiment 8.5M pairs in total were extracted.

Training details. The training described herein may be performed by the training module. During each epoch, an equal number of pairs are randomly sampled from each dataset to equalize disparities in dataset sizes. In an embodiment relatively high-resolution images are fed to the disclosed network that are for example 512 pixels in the largest dimension. To mitigate the high cost associated with such input, the disclosed networks may be trained sequentially, first on 224×224 images and then on larger 512-pixel images. The image aspect ratios are randomly selected for each batch (e.g., 16/9, 4/3, etc.), so that at test time the disclosed network is familiar with different image shapes. Images are cropped to the target aspect-ratio, and resized so that the largest dimension is 512 pixels.

Data augmentation techniques and training set-up are used. The disclosed network architecture includes a ViT-Large for the encoder (see Dosovitskiy et al.), a ViT-Base for the decoder and a DPT head (see Ranftl et al., “Vision transformers for dense prediction,” in ICCV, 2021, which is referred to hereinafter as “DPT” or “DPT-KITTI”). Note Section B.6.5 (below) sets forth additional details on the training and the network architecture. Before training, the network is initialized with the weights of a CroCo pretrained model. CroCo is a pretraining paradigm that has been shown to excel on various downstream 3D vision tasks and is thus suited to the disclosed framework. In Section B.4.6 the impact of CroCo pretraining and increase in image resolution is ablated.

Evaluation. In the remainder of this Section, DUSt3R is benchmarked on a representative set of classical 3D vision tasks, each time specifying datasets, metrics and comparing performance with other approaches. All results are obtained with the same DUSt3R model (the disclosed default model is denoted as ‘DUSt3R 512’, other DUSt3R models serves for the ablations), i.e., the disclosed model may not be finetuned on a particular downstream task. During testing, all test images are rescaled to 512 pixels while preserving their aspect ratio. Since there may exist different ‘routes’ to extract task-specific outputs from DUSt3R, as described in Section B.3.3 and Section B.3.4, it is noted each time the method is employed.

Qualitative results. DUSt3R yields high-quality dense 3D reconstructions even in challenging situations. See Section B.6.1 for visualizations of pairwise and multi-view reconstructions.

### Section B.4.1 Visual Localization

Dataset and metrics. DUSt3R is evaluated in this Section for the task of absolute pose estimation on the 7Scenes (see Shotton et al., “Scene coordinate regression forests for camera relocalization in RGB-D images”, in CVPR, pp. 2930-2937, 2013) and Cambridge Landmarks datasets (see Kendall et al., “PoseNet: a Convolutional Network for Real-Time 6-DOF Camera Relocalization”, in ICCV, 2015). 7Scenes contains 7 indoor scenes with RGB-D images from videos and their 6-DOF camera poses. Cambridge-Landmarks contains 6 outdoor scenes with RGB images and their associated camera poses, which are obtained via SfM. The median translation and rotation errors in (cm/°), respectively, are reported.

Protocol and results. To compute camera poses in world coordinates, DUSt3R is used as a 2D-2D pixel matcher (see Section B.3.3) between a query and the most relevant database images obtained using known image retrieval APGeM (see Revaud et al., “Learning with average precision: Training image retrieval with a listwise loss,” in ICCV, 2019). In other words, the raw pointmaps output from F(I^{Q}, I^{B}) without any refinement are used, where I^{Q} is the query image and I^{B} is a database image. The top 20 retrieved images for Cambridge-Landmarks and top 1 for 7Scenes are used, and query intrinsics are leveraged. For results obtained without using ground-truth intrinsics parameters, refer to Section B.6.4 (below).

Obtained results were compared against others for each scene of the 7Scenes and Cambridge-Landmarks datasets, where the median translation and rotation errors (cm/°) to feature matching (FM) based and end-to-end (E2E) learning-base methods. The disclosed systems and methods obtain comparable accuracy compared to other approaches, being feature-matching ones (e.g., HLoc, AS) or end-to-end learning based methods (e.g., DSAC, HSCNet, NeuMaps, SC-uLS), even managing to outperform strong baselines like HLoc in some cases. This is believed to be important for two reasons. First, DUSt3R may not be trained for visual localization in any way. Second, neither query image nor database images were seen during DUSt3R's training.

### Section B.4.2 Multi-View Pose Estimation

DUSt3R is evaluated in this Section on multi-view relative pose estimation after the global alignment from Section B.3.4.

Datasets. Following, two multi-view datasets, CO3Dv2 and RealEstate10k (Zhou et al., “Stereo Magnification: Learning View Synthesis Using Multiplane Images”, in SIGGRAPH, 2018) are used for the evaluation. CO3Dv2 contains 6 million frames extracted from approximately 37 k videos, covering 51 MS-COCO categories. The ground-truth camera poses are annotated using COLMAP (see Schonberger et al., “Structure-from-motion revisited”, in CVPR, 2016, and Schonberger et al, Pixelwise view selection for unstructured multi-view stereo”, in ECCV, 2016, which are hereinafter referred to as “COLMAP”) from 200 frames in each video. RealEstate10k is an indoor/outdoor dataset with 10 million frames from about 80K video clips, the camera poses being obtained by SLAM (Simultaneous Localization and Mapping) with bundle adjustment. The protocol introduced in PoseDiffusion (see Wang et al., “PoseDiffusion: Solving Pose Estimation via Diffusion-Aided Bundle Adjustment” in ICCV, 2023) is followed to evaluate DUSt3R on 41 categories from CO3Dv2 and 1.8K video clips from the test set of RealEstate10k. For each sequence, 10 frames are randomly selected and all possible 45 pairs are fed to DUSt3R.

Baselines and metrics. DUSt3R is compared to pose estimation results, obtained either from PnP-RANSAC or global alignment, against the learning-based RelPose (see Zhang et al., “RelPose: Predicting Probabilistic Relative Rotation for Single Objects in the Wild”, in ECCV, 2022), PoseReg and PoseDiffusion, and structure-based PixSFM (see Lindenberger et al., “Pixel-Perfect Structure-from-Motion with Feature metric Refinement,” in ICCV, pages 5967-5977, 2021), COLMAP+SPSG (COLMAP extended with SuperPoint (see DeTone et al., “Superpoint: Self-supervised Interest Point Detection and Description,” in CVPR Workshops, pages 224-236, 2018) and SuperGlue (see Sarlin et al., “SuperGlue: Learning Feature Matching with Graph Neural Networks,” in CVPR, pp. 4937-4946, 2020). Similar to PoseReg, the Relative Rotation Accuracy (RRA) and Relative Translation Accuracy (RTA) for each image pair to evaluate the relative pose error and select a threshold τ=15 to report RTA@15 and RRA@15 is reported. Additionally, the mean Average Accuracy (mAA)@30 is calculated, defined as the area under the curve accuracy of the angular differences at min(RRA@30,RTA@30).

Results. DUSt3R with global alignment may achieve high performance on the two datasets and surpasses PoseDiffusion. Moreover, DUSt3R with PnP also demonstrates superior performance over both learning and structure-based methods. It is worth noting that RealEstate10K results reported for PoseDiffusion are from the model trained on CO3Dv2. Nevertheless, this comparison is justified considering that RealEstate10K is not used either during DUSt3R's training. Performance is also reported with less input views (between 3 and 10) in Section B.6.3 (below), in which case DUSt3R also yields excellent performance on both benchmarks.

### Section B.4.3 Monocular Depth

For this monocular task, the same input image I is fed to the network as F(I, I). By design, depth prediction is the z coordinate in the predicted 3D pointmap.

Datasets and metrics. DUSt3R is benchmarked on two outdoor datasets (DDAD (see Guizilini et al., “3D packing for self-supervised monocular depth estimation”, in CVPR, pp 2482-2491, 2020), KITTI (see Geiger et al., “Vision meets robotics: The KITTI dataset”, in Int. J. Robotics Res., 32(11):1231-1237, 2013)) and three indoor datasets (NYUv2 (see Silberman et al., “Indoor segmentation and support inference from RGBD images” in ECCV, pp. 746-760, 2012), BONN (see Palazzolo et al., “Refusion: 3d reconstruction in dynamic environments for RGB-D cameras exploiting residuals”, in IROS 2019), TUM (see Sturm et al., “A benchmark for the evaluation of RGB-D SLAM systems”, in IEEE IROS, pp. 573-580, 2012)) datasets. DUSt3R's performance is compared to other methods categorized in supervised, self-supervised and zero-shot settings, this last category corresponding to DUSt3R. Two metrics commonly used in the monocular depth evaluations are used: the absolute relative error AbsRel between target y and prediction ŷ,

$$AbsRel = \frac{\vert y - \hat{y} \vert}{y} ,$$

and the prediction threshold accuracy, δ_{1.25}=max(ŷ/y, y/ŷ)<1.25.

Results. In zero-shot setting, SlowTv (see Spencer et al., “Kick back & relax: Learning to reconstruct the world by watching slowtv”, in ICCV, 2023) performs relatively well. This approach collected a large mixture of curated datasets with urban, natural, synthetic and indoor scenes, and trained one common model. For every dataset in the mixture, camera parameters are known or estimated with COLMAP. DUSt3R adapts well to outdoor and indoor environments. It outperforms the self-supervised baselines (e.g., Monodepth2, SC-DepthV3, Monodepth2, SC-DepthV3) and performs on-par with other supervised baselines (e.g., NeWCRFs).

### Section B.4.4 Multi-View Depth

DUSt3R is evaluated for the task of multi-view stereo depth estimation. Depthmaps, as the z-coordinate of predicted pointmaps, are extracted. In the case where multiple depthmaps are available for the same image, all predictions are rescaled to align them together and aggregate all predictions via an averaging weighted by the confidence.

Datasets and metrics. Following Schroppel et al. (in “A benchmark and a baseline for robust multi-view depth estimation” in 3DV, pp. 637-645, 2022), it is evaluated on the DTU, ETH3D, Tanks and Temples, and ScanNet (see Dai et al., “ScanNet: Richly-annotated 3d reconstructions of indoor scenes”, in CVPR, 2017) datasets. The Absolute Relative Error (rel) and Inlier Ratio (τ) with a threshold of 1.03 on each test set and the averages across all test sets are reported. Note that the ground-truth camera parameters and poses nor the ground-truth depth ranges are not leveraged, the predictions herein are only valid up to a scale factor. In order to perform quantitative measurements, predictions are normalized using the medians of the predicted depths and the ground truth ones, as advocated by Schroppel et al.

Results. DUSt3R achieves high accuracy on ETH-3D and outperforms other methods overall, even those using groundtruth camera poses. Timewise, the disclosed approach is also much faster than the traditional COLMAP pipeline. This showcases the applicability of the disclosed systems and methods on a large variety of domains, either indoors, outdoors, small scale or large scale scenes, while not having been trained on the test domains, except for the ScanNet test set, since the train split is part of the Habitat dataset.

### Section B.4.5 3D Reconstruction

Finally, the quality of the disclosed full reconstructions obtained after the global alignment procedure described in Section B.3.4 is measured. Again it is emphasized that the disclosed systems and methods method are the first one to enable global unconstrained MVS, in the sense that there is no prior knowledge regarding the camera intrinsic and extrinsic parameters. In order to quantify the quality of the disclosed reconstructions, the predictions are aligned to the ground-truth coordinate system. This is done by fixing the parameters as constants in Section B.3.4. This leads to consistent 3D reconstructions expressed in the coordinate system of the ground-truth.

Datasets and metrics. The disclosed predictions are evaluated on the DTU dataset. The disclosed network is applied in a zero-shot setting, i.e., the disclosed model as is applied without performing any finetuning on the DTU training set. The accuracy for a point of the reconstructed shape may be defined as the smallest Euclidean distance to the ground-truth, and the completeness of a point of the ground-truth as the smallest Euclidean distance to the reconstructed shape. The overall may be the mean of both previous metrics.

Results. Other methods all leverage GT (Ground Truth) poses and train specifically on the DTU training set whenever applicable. Furthermore, results on this task are usually obtained via sub-pixel accurate triangulation, requiring the use of explicit camera parameters, whereas the disclosed systems and methods use regression. Yet, without prior knowledge about the cameras, an average accuracy of 2.7 mm is reached, with a completeness of 0.8 mm, for an overall average distance of 1.7 mm. This level of accuracy is of great use in practice, considering the plug-and-play nature of the disclosed systems and methods.

### Section B.4.6 Ablations

The impact of the CroCo pretraining and image resolution on DUSt3R's performance was ablated. Overall, the observed consistent improvements suggest the crucial role of pretraining and high resolution in modern data-driven approaches.

### Section B.5 Conclusion

A novel paradigm has been presented to solve not only 3D reconstruction in-the-wild without prior information about scene nor cameras, but a whole variety of 3D vision tasks as well.

### Section B.6 Results and Extensions

This Section provides additional details and qualitative results of DUSt3R. First, Section B.6.1 presents qualitative pairwise predictions of the presented architecture on challenging real-life datasets. Extended related works are set forth in Section B.6.2, encompassing a wider range of methodological families and geometric vision tasks. Section B.6.3 provides auxiliary ablative results on multi-view pose estimation, that are not set out in Section B.4. Then results are reported in Section B.6.4 on an experimental visual localization task, where the camera intrinsics are unknown. Finally, training and data augmentation procedures are detailed in Section B.6.5.

### Section B.6.1 Qualitative Results

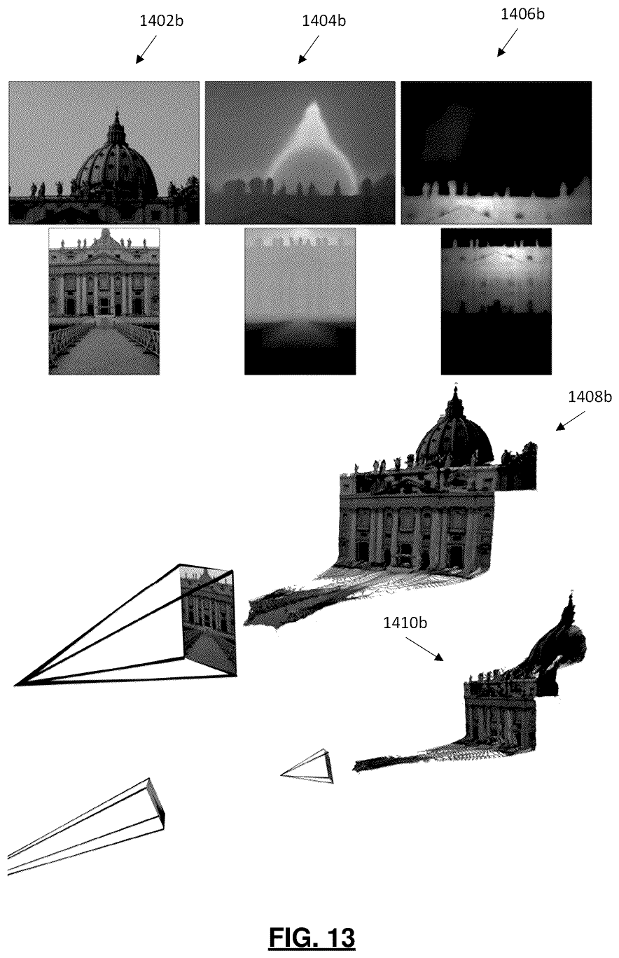

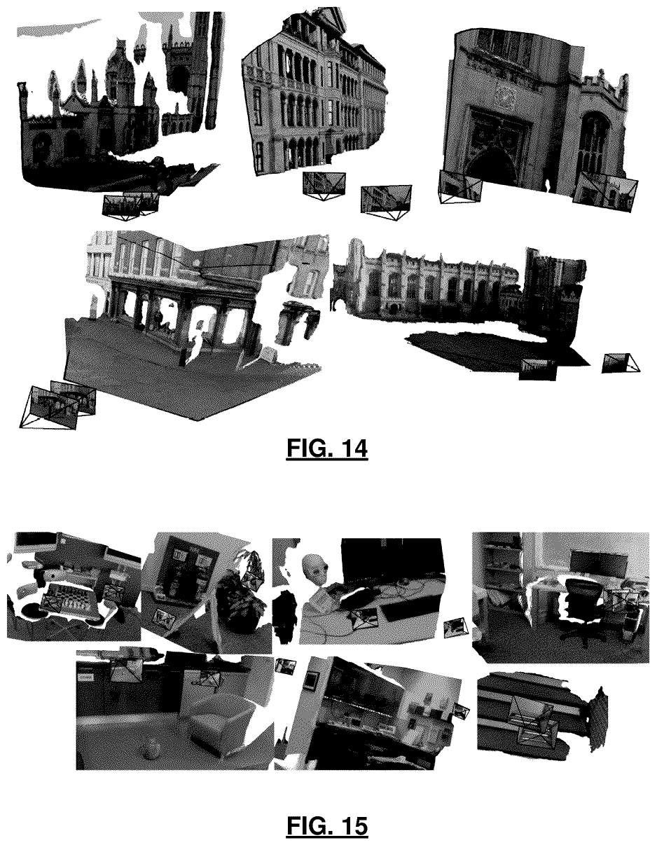

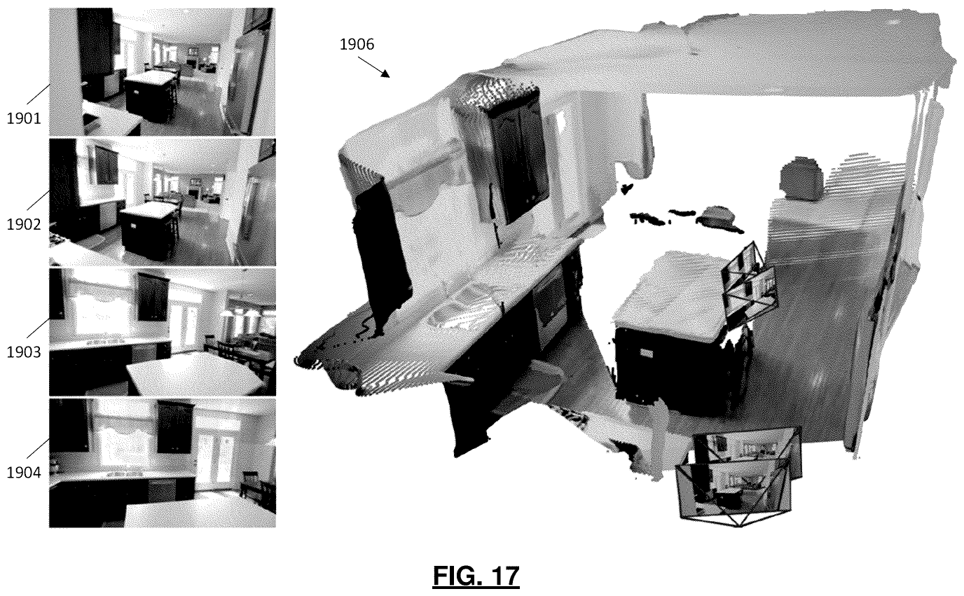

Point-cloud visualizations. Some visualization of DUSt3R's pairwise results are presented in FIGS. 12 to 16D. FIGS. 12 and 13 are examples of 3D reconstruction of an unseen MegaDepth scene from two images 1402; this is the raw output of the DUSt3R network (i.e., the output depthmaps 1404 and confidence maps 1406, as well as two different viewpoints on the pointclouds 1408 and 1410). The scenes in FIGS. 14 and 15 show raw output of the DUSt3R network (i.e., new viewpoints on the pointclouds, where camera parameters may be recovered from the raw pointmaps) from five scenes in FIG. 14 (i.e., Kings College (top-left), Old Hospital (top-middle), St Mary's Church (top-right), Shop Façade (bottom-left), Great Court (bottom-right) and seven scenes in FIG. 17 (i.e., Chess (top-left), Fire (top-middle-left), Heads (top-middle-right), Office (top-right), Pumpkin (bottom-left), Kitchen (bottom-middle, Stairs (bottom-right)).

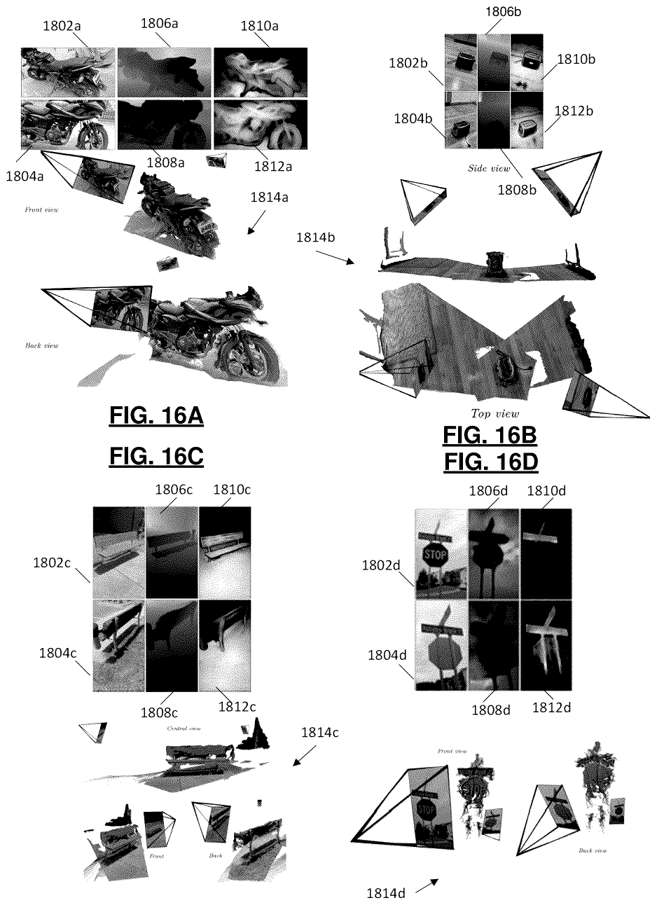

FIGS. 16A, 16B, 16C and 16D show examples of 3D reconstructions from nearly opposite viewpoints for each of 4 cases (respectively, a motorcycle, a toaster, a bench, and a stop sign); in each of the Figures are shown: two input images 1802 and 1804, corresponding depthmaps 1806 and 1808 output by the DUSt3R network, corresponding confidence maps 1810 and 1812 output by the DUSt3R network, and different views on the colored point-clouds 1814. As with other examples, camera parameters may be recovered from raw pointmaps. Further, these examples show that the DUSt3R network handles drastic viewpoint changes without apparent issues, even when there is almost no overlapping visual content between images (e.g., for the stop sign and motorcycle, which example cases are randomly chosen from the set of unseen sequences).

Note the scenes in FIGS. 12 to 16D were never seen during training and were not cherry-picked. Also, these results were not post-processed, except for filtering out low-confidence points (based on the output confidence) and removing sky regions for the sake of visualization (i.e., these figures accurately represent the raw output of DUSt3R). Overall, the proposed systems and methods are able to perform highly accurate 3D reconstruction from just two images. FIG. 17 is a reconstruction example from four random frames 1901 to 1904 of an indoor sequence. In FIG. 17, the output 1906 of the DUSt3R network is shown after the global alignment stage (i.e., the resulting point-cloud and the recovered camera intrinsics and poses). In this case, the DUSt3R network has processed all pairs of the 4 input images, and outputs 4 spatially consistent pointmaps along with the corresponding camera parameters. Note that, for the case of image sequences captured with the same camera, the fact that camera intrinsics must be identical for every frame (i.e., all intrinsic parameters are optimized independently) is never enforced. This remains true for all results reported in Section B.6 and in Section B.4 (e.g., on multi-view pose estimation with the CO3Dv2 and RealEstate10K datasets).

### Section B.6.2 Additional Related Works

Section B.2 covered some other works. Because this work covers a large variety of geometric tasks, Section B.2 is completed in this Section with additional topics.

Implicit Camera Models. The disclosed systems and methods may not explicitly output camera parameters. Likewise, there are works aiming to express 3D shapes in a canonical space that is not directly related to the input viewpoint. Shapes can be stored as occupancy in regular grids, octree structures, collections of parametric surface elements, point clouds encoders, free-form deformation of template meshes or per-view depthmaps. While these approaches arguably perform classification and not actual 3D reconstruction, all-in-all, they work only in very constrained setups, usually on ShapeNet (see Chang et al., “ShapeNet: An Information-Rich 3D Model Repository”, in arXiv:1512.03012, 2015) and have trouble generalizing to natural scenes with non object-centric views. The question of how to express a complex scene with several object instances in a single canonical frame had yet to be answered: in this disclosure, the reconstruction is expressed in a canonical reference frame, but due to the disclosed scene representation (pointmaps), a relationship is preserved between image pixels and the 3D space, and thus 3D reconstruction may be performed consistently.

Dense Visual SLAM. In visual SLAM, 3D reconstruction and ego-motion estimation may use active depth sensors. Dense visual SLAM from RGB video stream may be able to produce high-quality depth maps and camera trajectories, but they inherit the traditional limitations of SLAM, e.g., noisy predictions, drifts and outliers in the pixel correspondences. To make the 3D reconstruction more robust, R3D3 (see Schmied et al., “R3D3: Dense 3D Reconstruction of Dynamic Scenes from Multiple Cameras”, in arXiv:2308.14713, 2023) jointly leverages multi-camera constraints and monocular depth cues. Most recently, GO-SLAM (see Zhang et al., “GO-SLAM: Global optimization for consistent 3d instant reconstruction”, in ICCV, pp. 3727-3737, October 2023) proposed real-time global pose optimization by considering the complete history of input frames and continuously aligning all poses that enables instantaneous loop closures and correction of global structure. Still, all SLAM methods assume that the input consists of a sequence of closely related images, e.g., with identical intrinsics, nearby camera poses and small illumination variations. In comparison, the disclosed systems and methods handle completely unconstrained image collections.

3D reconstruction from implicit models has undergone advancements, such as by the integration of neural networks. Multi-Layer Perceptrons (MLP) may be used to generate continuous surface outputs with only posed RGB images. Others involve density-based volume rendering to represent scenes as continuous 5D functions for both occupancy and color, showing ability in synthesizing novel views of complex scenes. To handle large-scale scenes, geometry priors to the implicit model may be used, leading to much more detailed reconstructions. In contrast to the implicit 3D reconstruction, this disclosure focuses on the explicit 3D reconstruction and showcases that DUSt3R can not only have detailed 3D reconstruction but also provide rich geometry for multiple downstream 3D tasks.

RGB-pairs-to-3D takes its roots in two-view geometry and may be considered as a stand-alone task or an intermediate step towards the multi-view reconstruction. This process may involve estimating a dense depth map and determining the relative camera pose from two different views. This problem may be formulated either as pose and monocular depth regression or pose and stereo matching. A goal is to achieve 3D reconstruction from the predicted geometry. In addition to reconstruction tasks, learning from two views also gives an advance in unsupervised pretraining; CroCo introduces a pretext task of cross-view completion from a large set of image pair to learn 3D geometry from unlabeled data and to apply this learned implicit representation to various downstream 3D vision tasks. Instead of focusing on model pretraining, the systems and methods herein leverage this pipeline to directly generate 3D pointmaps from the image pair. In this context, the depth map and camera poses are only by-products in the disclosed pipeline.

### Section B.6.3 Multi-View Pose Estimation

Additional results are included for the multi-view pose estimation task from Section B.4.2. Namely, the pose accuracy is computed for a smaller number of input images (they are randomly selected from the entire test sequences). The disclosed systems and methods consistently outperform other methods on the CO3Dv2 dataset by a large margin, even for small number of frames. As can be observed in FIG. 16A-16D, DUSt3R handles opposite viewpoints (i.e., nearly 180° apart) seemingly without much trouble. In the end, DUSt3R obtains relatively stable performance, regardless of the number of input views. When comparing with PoseDiffusion on RealEstate10K, performances are reported with and without training on the same dataset. Note that DUSt3R's training data includes a small subset of CO3Dv2 (50 sequences for each category are used, i.e., less than 7% of the full training set) but no data from RealEstate10K whatsoever.

An example of reconstruction on RealEstate10K is shown in FIG. 17. The disclosed systems and methods generate a consistent pointcloud despite wide baseline viewpoint changes between the first and last pairs of frames.

### Section B.6.4 Visual Localization

Additional results of visual localization on the 7-scenes and Cambridge-Landmarks datasets are included herein. Namely, experiments with a scenario where the focal parameter of the querying camera is unknown were performed. In this case, the query image and a database image are input into DUSt3R, and an un-scaled 3D reconstruction is output. The resulting pointmap is then scaled according to the ground-truth pointmap of the database image, and extract the pose as described in Section B.3.3. This method performs reasonably well on the 7-scenes dataset, where the median translation error is on the order of a few centimeters. On the Cambridge-Landmarks dataset, however, considerably larger errors are obtained. After inspection, it is found that the ground-truth database pointmaps are sparse, which prevents any reliable scaling of the disclosed reconstruction. On the contrary, 7-scenes provides dense ground-truth pointmaps. Further work believed to be necessary for “in-the-wild” visual-localization with unknown intrinsics.

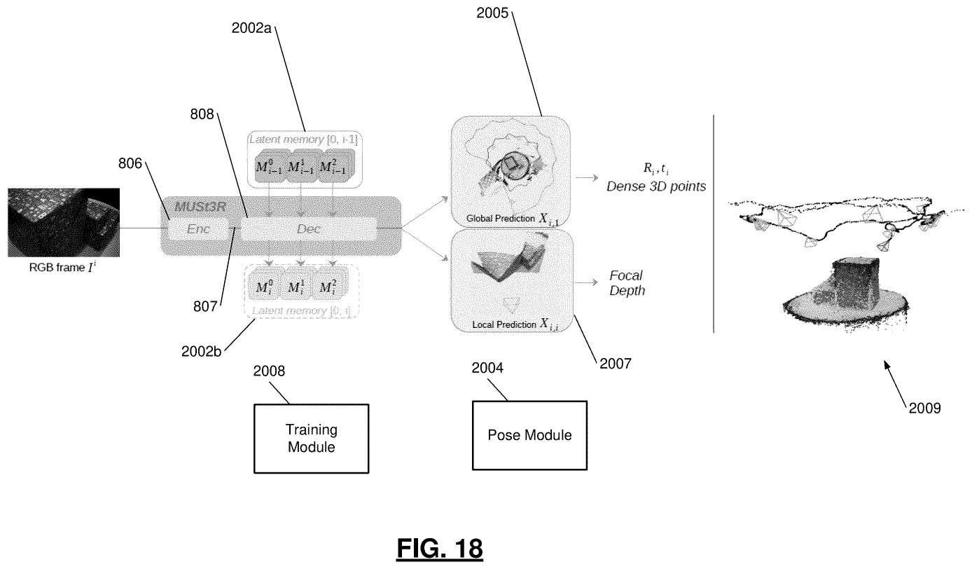

FIG. 18 is a functional block diagram of an example extension of the DUSt3R network. An i-th image is illustrated in FIG. 18, but i is an integer greater than or equal to 2. As such, two or more images are input to the network. In this example, the network may be referred to as MUSt3R. On the left of FIG. 18 provides a high level block diagram of the uncalibrated reconstruction framework: an input RGB, MUSt3R network architecture, and the memory state. The network predicts both local Xi,i pointmap 2007 and global Xi,1 pointmap 2005, from which camera focal parameters, depth map, and pose and a dense 3D reconstruction can efficiently be recovered, as seen in global reconstruction 2009. The latent memory 2002 of the decoder 808 is optionally updated from latent memory [0,i−1] 2002a to latent memory [0,i] 2002b according to heuristics depending on the scenario, as discussed further below. The global reconstruction 2009 provides a qualitative example of uncalibrated Visual Odometry on the ETH3D “boxes” sequence in the online setting.

DUSt3R provides a novel paradigm in geometric computer vision by proposing a model configured to provide dense and unconstrained Stereo 3D Reconstruction of arbitrary image collections with no prior information about camera calibration nor viewpoint poses. DUSt3R may process image pairs, regressing local 3D reconstructions for alignment in a global coordinate system.

The number of pairs, growing quadratically, may be an inherent limitation that may impede robust and fast optimization in the case of large image collections.

The present application involves an extension of DUSt3R, Ust3R, from pairs to multiple views, that addresses all aforementioned concerns. MUSt3R provides a Multi-view Network for Stereo 3D Reconstruction, or MUSt3R, that modifies the DUSt3R architecture by making it symmetric and extending it to directly predict 3D structure for all views in a common coordinate frame. MUSt3R may involve the model using a multi-layer memory mechanism which allows to reduce the computational complexity and to scale the reconstruction to large collections, inferring 3D pointmaps at high frame-rates with limited added complexity. The framework is designed to perform 3D reconstruction both offline and online, and hence can be seamlessly applied to SfM and SLAM scenarios showing high performance on various 3D downstream tasks, including uncalibrated Visual Odometry, relative camera pose, 3D reconstruction and multi-view depth estimation.

As stated above, DUSt3R provides dense and unconstrained Stereo 3D reconstruction of image collections, without any prior information about camera calibration nor viewpoint poses. By casting the pairwise reconstruction problem as a regression of pairs of pointmaps, where a pointmap is or includes a dense mapping between pixels and 3D points, it effectively relaxes the hard constraints of usual projective camera models. The pointmap representation encompasses both 3D geometry and the camera parameters, and allows unification and joint solving of various 3D vision tasks, such as depth, camera pose and focal length estimation, dense 3D reconstruction and pixel correspondences. Trained using a large set of image pairs with ground-truth annotations for depth and camera parameters, DUSt3R shows high performance and generalization across various real-world scenarios with different camera sensors in zero-shot settings.

The DUSt3R architecture works seamlessly in monocular and binocular cases, yet when feeding many images. Since the predicted pointmaps are expressed in a local coordinate system defined by the first image of each pair, all predictions live in different coordinate systems. This design may then include global aligning as discussed above to align all predictions into one global coordinate frame.

The MUSt3R architecture is scalable to large image collections of arbitrary scale, and can infer the corresponding pointmaps in the same coordinate system at high frame-rates. MUSt3R extends the DUSt3R architecture through several modifications—making it symmetric and adding a working memory mechanism—with limited added complexity.

MUSt3R, beyond handling offline reconstruction of unordered image collections in a Structure-from-Motion (SfM) scenario, can also tackle the task of dense Visual Odometry (VO) and SLAM, which aims to predict online the camera pose and 3D structure of a video stream recorded by a moving camera. MUSt3R can seamlessly leverage the memory mechanism to cover both scenarios such that no architecture change is required and the same network can operate either task in an agnostic manner.

The MUSt3R architecture is symmetric and enables N-view predictions in metric space, includes a memory mechanism that allows to decrease the computational complexity for both offline and online reconstructions, and provides a high level of performance in both unconstrained reconstruction scenarios in terms of estimating field-of-view, camera pose, 3D reconstruction and absolute scale without sacrificing inference speed.

As discussed further below, the memory mechanism can be iteratively updated to handle an unlimited number of views. MUSt3R is able to seamlessly tackle both offline reconstruction and sequential causal applications, such as dense Visual Odometry, at a high framerate.

As discussed above, DUSt3R may have a binocular architecture and be configured to jointly infer dense 3D reconstruction and camera parameters from pairs of images, by mapping a pair of dense images to 3D pointmaps that live in a common coordinate system. A transformer based network predicts a 3D reconstruction given two input images, in the form of two dense 3D pointmaps

$$\{ {X}_{i , 1} \} ∈ {ℝ}^{H \times W \times 3} , i ∈ \{ 1 , 2 \}$$

i.e., a dense 2D-to-3D mapping between each pixel p of the images {Iᵢ} and the corresponding 3D point it observes X_{i,1}[p]∈ [symbol] ³ expressed in the coordinate system of the first camera.

Formally, given a pair of images {Iᵢ}, they are first split into patches, or tokens, that are encoded by a Siamese ViT encoder, yielding two latent representations Eᵢ. These representations are projected linearly to

$${D}_{i}^{0} = L i n ( {E}_{i} )$$

which is the input to a set of L intertwined layers of decoders blocks

$${\{ {Dec}_{1}^{l} , {Dec}_{2}^{l} \}}_{l = 1}^{L} .$$

These blocks process the two images jointly, exchanging information via cross-attention at each layer to understand the spatial relationship between viewpoints and the global 3D geometry of the scene. Finally, the prediction heads (e.g., 811)

$$\{ {Head}_{i}^{3 D} \}$$

regress the final pointmaps X_{i,1} and their associated confidences Cᵢ from the output of the last layers

$${D}_{i}^{L} ,$$

and optionally Ei, typically leveraged in combination with DPT prediction heads:

$${X}_{i , 1} , {C}_{i} = {Head}_{i}^{3 D} ( {E}_{i} , {D}_{i}^{L} ) \qquad ( A )$$

DUSt3R is trained in a fully-supervised manner using a pixel-wise regression loss as discussed above

$${ℓ}_{regr} ( i , j ) = {\sum }_{p ∈ {I}_{i}} ‖ \frac{1}{z} {X}_{i , j} [ p ] - \frac{1}{\hat{z}} {\hat{X}}_{i , j} [ p ] ‖ , \qquad ( B )$$

where j=1 represent the reference view and p is a pixel for which the ground-truth 3D point \hat{X}_{i,j}[p]∈ [symbol] ³ is defined.

Normalizing factors z,\hat{z} may be used to make the reconstruction scale-invariant. The normalizing factors may be the mean distance of all valid 3D points to the origin. The present application may involve regressing metric predictions when possible, e.g., set z:=\hat{z} whenever ground truth is metric. This loss may be combined with a confidence aware loss [symbol] _{conf}.

Regarding the architecture of the MUSt3R network, the DUSt3R network is extended to N of views/images where N is an integer greater than or equal to 2 or greater than or equal to 3. As detailed before, the DUSt3R binocular architecture features 2 distinct decoders. Naively extending to N views may not scale, as it may involve a set of N distinct decoders.

The MUSt3R network instead makes the architecture symmetric with a single Siamese decoder 808 that shares weights between views/images. This architecture naturally scales to N views while halving the number of trainable parameters in the decoder 808 relative to DUSt3R. The MUSt3R network predicts an additional pointmap that can be leveraged for efficient camera parameters estimation.

Regarding the symmetric MUSt3R network, the duplicated decoders and heads may be redundant in DUSt3R. The MUSt3R network therefore replaces the duplicated decoders with a Siamese decoder 808 and a Siamese head with shared weights, denoted as Dec and Head^{3D}, respectively, dropping the subscript notation. To identify the reference image I₁, which defines the common coordinate system, a learnable embedding B to

$${D}_{2}^{0}$$

is added for the shared decoder,

$${D}_{2}^{0} = L i n ( {E}_{2} ) + B \qquad ( C )$$

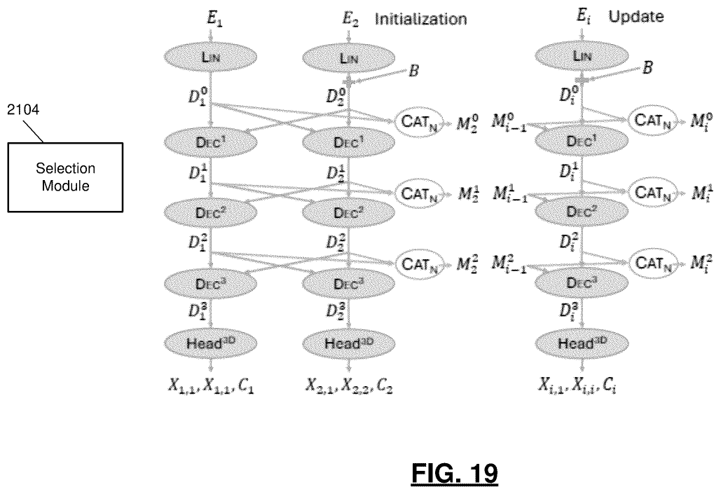

The MUSt3R network extends to efficiently handle multiple (e.g., three or more) input images. This can be done by changing the behavior of the cross attention in each decoder block Dec^{l}. Each decoder block (e.g., see FIG. 19) is residual and includes self-attention (intra-view), followed by cross-attention (inter-view), and a final multi layer perceptron (MLP). Therefore, the cross-attention operates between tokens of image Iᵢ and tokens of all other j≠i images. In more detail, let Cat_{N} denote the concatenation of image tokens in the sequence dimension and

$${M}_{n}^{l} = {Cat}_{N} ( {D}_{1}^{l} , … , {D}_{n}^{l} )$$

the concatenation of tokens from n images at each layer l. Similarly,

$${M}_{n , - i}^{l} = {Cat}_{N} ( {D}_{1}^{l} , … , {D}_{i - 1}^{l} , {D}_{i + 1}^{l} , … , {D}_{n}^{l} )$$

denotes the concatenation of tokens for all but the i-th image. In this notation, the decoder 808 applies, at each layer l, cross attention between tokens of image Ii and tokens of all other images:

$${D}_{i}^{l} = {DEC}^{l} ( {D}_{i}^{l - 1} , {M}_{n , - i}^{l - 1} ) \qquad ( D )$$

In the DUSt3R network, X_{1,1} is used to estimate the intrinsics of I₁, and a second forward with the symmetric pair (I₂, I₁) allows prediction of X_{2,2} in order to estimate the intrinsics of I₂. The MUSt3R network is a multi-view model that preserves this ability with a low computational cost. In the MUSt3R network, the prediction head outputs an additional X_{i,i} pointmap, such as follows:

$$( {X}_{i , 1} , {X}_{i , i} , {C}_{i} ) = {Head}^{3 D} ( {D}_{i}^{L} ) , i ∈ \{ 1 … n \} \qquad ( E )$$

With such a change, the pose module 2004 can recover the relative pose between I₁ and Iᵢ by estimating the transformation between X_{1,1} and X_{i,1} such as via Procrustes analysis, which is simpler and faster than PnP, as can be demonstrated empirically. The pose module 2004 may determine the relative pose regardless of the focal length, which may be used in PnP.

The MUSt3R network is iterative. Based on the architecture, the MUSt3R network includes iteratively updated memory 2002 that is used by the decoder module 808 which allows to efficiently process N images, offline or online, and 3D feedback is injected to earlier layers through the extra MLP.

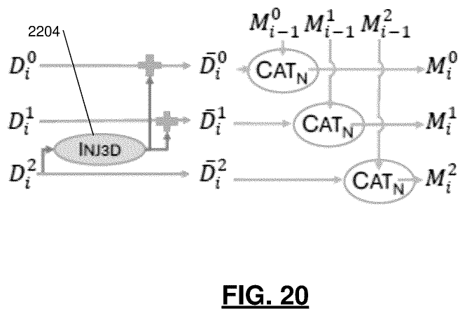

A functional block diagram of example architecture of the decoder module 808 is illustrated in FIG. 19. A functional block diagram illustrating an example of the injection (Inj3D) is included in FIG. 20.

FIG. 19 illustrates an example architecture for a decoder of depth L with a linear head (Head^{3D}) and without the injection module of FIG. 20 for simplicity. The left side of FIG. 19 illustrates initialization with encodings of two images E₁ and E₂. The right side of FIG. 19 illustrates how the memory is used and updated given a new image. In FIG. 19, L=3, but L is an integer greater than equal to 2.

In practice N may be large, making cross-attention on large token sequences computationally intensive. In some scenarios the images might arrive sequentially, for instance in visual odometry where a time series of images may be captured as a vehicle moves. In order to handle a large number of images the MUSt3R network is used iteratively, with the usage of a memory. The memory may include the previously computed

$${M}_{n}^{l}$$

of every layer. As shown in FIG. 19, when a new image Iₙ₊₁ is received, the decoder 808 cross-attends with the saved tokens, such as described by the following. For each layer:

$${D}_{n + 1}^{l} = {Dec}^{l} ( {D}_{n + 1}^{l - 1} , {M}_{n}^{l - 1} ) \qquad ( F )$$

Features

$${D}_{n + 1}^{l}$$

of the new image is added to the memory by concatenating the features to the current memory

$${M}_{n}^{l} ,$$

thus expanding the memory to

$${M}_{n + 1}^{l} .$$

By caching the previously computed

$${D}_{i}^{l}$$

at every layer, the MUSt3R network is causal: every new image attends to previously seen images, but these are not updated. With this architecture, it is possible to process an image without appending new tokens to the memory. This may be referred to as rendering. It can be used to break the causality of the model, by re-computing pointmaps given tokens of future frames. Rendering may be performed at a predetermined time, such as at the end of a video sequence, when all images are in the memory.

The MUSt3R network may process frames one by one (sequentially) or n by n (n being an integer >1). Sequential predictions may perform better than n by n processing in various implementations.

A feedback mechanism may be used between the memory tokens

$${M}_{n}^{l}$$

of later layers or the last layer towards those of earlier layers

$${M}_{n}^{k} , k < l . {M}_{i}^{0}$$

may be the concatenation of projected encoder features

$${D}_{i}^{0}$$

and may lack knowledge of the other frames. The token representations at the last layer may include more global 3D information than those at earlier layers. In various implementations, the MUSt3R network may augment all memory tokens with information from the last layer l=L−1 in order to propagate global 3D knowledge to every layer. This is feasible in the iterative framework described above since the last layers of the past frames already contain this information.

Formally, denote the set of previous and new images by P and N, respectively. To inject such information from the last layer into the earlier layers, an injection module 2204 (a feedback mechanism) augments

$${M}_{n}^{l} with {M}_{n}^{l} = Ca {t}_{N} ( {\overline{D}}_{0}^{l} , … , {\overline{D}}_{n}^{l} )$$

where

$${\overline{D}}_{i}^{l} = \{ \begin{matrix}{D}^{l} + INJ 3 d ( {D}_{i}^{L - 1} ) , & ∀ l < L - 1 and i ∈ p \\ {D}_{i}^{l} & l < L - l or i ∈ n\end{matrix} \qquad ( G )$$

where INJ3d (the injection module 2204) includes a normalization layer (e.g., Layer Norm) followed by an M (M being an integer, such as 2) layer MLP (e.g., see FIG. 20). The injection module 2204 provides significant improvement in accuracy.

Memory use grows linearly with the number of images. To mitigate the increasing memory associated with larger sets of images, a selection module 2104 may select (e.g., using a heuristic selection that selects an image to be added to memory when it presents enough new information compared to images previously added to memory) memory tokens. Selecting which image tokens are added to the memory increases accuracy and enables scaling by replacing the concatenation of all image tokens by a subset of them. Two scenarios are considered below: online, where frames of a video are received one by one (in a time series), and offline, involving an unordered collection of images.

In the online example, the MUSt3R network uses a running memory and 3D scene of current observations which are updated on-the-fly. The memory and the scene are initialized from the predictions of the first image. This is illustrated on the left of FIG. 19. Then, the MUSt3R network updates based on each received new image attending to the current memory. This is illustrated on the right of FIG. 19 and leads to a prediction of both dense visible geometry and camera parameters.

The MUSt3R network determines whether to keep the current prediction based on the spatial discovery rate between the predicted pointmap

$${X}_{1}^{i}$$

and the current scene, keeping a frame when the MUSt3R network observes a significantly new part of the scene, or from a different enough viewpoint.

To this aim, the MUSt3R network may store the scene as a set of KDTrees. KDTrees is described in Jon Louis Bentley, Multidimensional Binary Search Trees Used for Associative Searching, Communications of the ACM, 18(9):509-517, 1975, which is incorporated herein in its entirety. KDtrees is a space partitioning data structure for organizing points in a k-dimensional space.

When building or querying the trees, each 3D point is associated to a tree by index based on the viewing direction of the observation. The MUSt3R network may do this by splitting the sphere of viewing directions into regular octants. The MUSt3R network may discretize the view direction of each pixel in spherical coordinates, to map it to the index of the relevant octant. Each pixel is thus mapped to a specific tree, then used to recover the nearest distance to the current scene. The MUSt3R network may normalize the distance by the depth at this pixel. The discovery rate of a frame is simply the p-th percentile of the normalized distances. The MUSt3R network may add the frame to the memory and the 3D points and view directions to the current 3D scene if the discovery rate is above a given threshold τ_{d}, i.e., the incoming frame observes enough new regions of the scene. For example only, τ_{d} may be 85% of the pixels have to be farther than τ_{d}, =5% of the depth value.

An example of kept memory frames are shown as pyramids in FIG. 18. Note that this approach is purely causal since each view only sees the past frames, but the causality can be broken by rendering again all images.

Regarding the offline example, ASMK (Aggregated Selective Match Kernels) image retrieval may be used by the MUSt3R network using the encoder features Ei of all images Ii. The MUSt3R network may leverage the encoded images with minimal computational overhead. Farthest point sampling may be used by the MUSt3R network to select a predetermined number of keyframes. The MUSt3R network selects an ordering of the images such as to observe the ones that maximize the overlap first, for more stability in the predictions. The ordering may be as follows: start with the keyframe which is the most connected to the others; then a greedy loop iteratively adds the other images by order of highest similarity to the current view set. These keyframes are sequentially passed through the MUSt3R network to build a latent representation of the whole scene. Then all the images from this memory are rendered. Note that it is possible to forward all images in an iterative manner.

A training module 2008 trains the MUSt3R network. The training module 2008 may pre-train the MUSt3R network using pairs of images and may train the MUSt3R network in multiple portions. First the training module 2008 may train the MUSt3R network for metric predictions. The training may be based on predicting points that could be far apart in a large scene. For a better convergence and performance on distant points, the training module 2008 may compute in log space:

$$f : x \to \frac{x}{‖ x ‖} log ( 1 + ‖ x ‖ ) , \qquad ( H )$$

$${X}_{i , j}^{′} [ p ] = f ( \frac{1}{z} {X}_{i , j} [ p ] ) , {\hat{X}}_{i , j}^{′} [ p ] = f ( \frac{1}{\hat{z}} {\hat{X}}_{i , j}^{′} [ p ] ) , \qquad ( I )$$

$${l}_{regr} ( i , j ) = {\sum }_{p ∈ {I}_{i}} {X}_{i , j}^{′} [ p ] - {\hat{X}}_{i , j}^{′} [ p ] \qquad ( J )$$

The training module 2008 may start training the MUSt3R network with a linear head initialized with a decoder depth L=12 on 224 resolution images. Then, the training module 2008 may finetune for 512 resolution (e.g., with varying aspect ratios). The training module 2008 may train the MUSt3R network with multiple views, starting from the above trained symmetric initialization. In various implementations, a total number of N=10 images per scene may be used for the training. In various implementations, the training module 2008 may freeze the encoder 806 during the training and train the decoder 808.

During training, the training module 2008 may initialize the memory of the decoder 808 from two images, and update the memory based on the individual images as illustrated in FIG. 19.

The training loss may be split in two steps: 1) the MUSt3R network may predict the pointmaps of a predetermined number (e.g., randomly chosen) n, 2≤n≤N of views, and use the latent embeddings to populate the memory, and 2) the MUSt3R network may render all views, including the n memory frames from this memory, meaning the MUSt3R network obtains in the end n+N predictions that correspond to the concatenation of the n and N views. The training module 2008 may train the MUSt3R network based on minimizing a loss:

$$ℒ = {\sum }_{i ∈ 1}^{n + M} {l}_{regr} ( i , 1 ) + {l}_{regr} ( i , i ) \qquad ( K )$$

To increase robustness and favor redundancy, the training module 2008 may augment the training with a token dropout. The memory tokens from the first image I₁ are protected as it plays a particular role for the 3D points are represented in the coordinates of the first camera. Token dropping is made for each incoming frame on the current memory and is consistent across layers, such that if a token is removed, it should not appear in any layer. A predetermined dropout probability may be used, such as 0.05 (0.15) for 224 (512) resolutions, respectively.

Regarding FIG. 19, an example architecture for decoder of depth L=3, a Linear Head 3D and without the injection module 2204 is provided. The left side shows initialization with two images. The right side shows how the memory is used and updated by the decoder 808 for a new image/frame.

FIG. 20 is an example architecture for the feedback mechanism (injection module 2204) of the decoder 808 including the injection module 2204 for the decoder 808 of depth L=3. As illustrated, the output of the injection module 2204 of the last layer of the decoder 808 (layer 2 in the example of FIG. 20) is added (summed or concatenated) with the outputs of all of the previous decoder layers (layers 0 and 1 in the example of FIG. 20). These are then used to update the memory for the respective layers of the decoder 808.

Experimental results demonstrate the usability and performance of the MUSt3R network in unconstrained scenarios, such as uncalibrated Visual Odometry (VO), relative pose estimation, 3D reconstruction and multi-view depth estimation, without access to the camera using a pipeline of striking versatility and simplicity.

The MUSt3R network provides a new multi-view network for 3D reconstruction of large image collections which operates in offline and online scenarios at high speed.

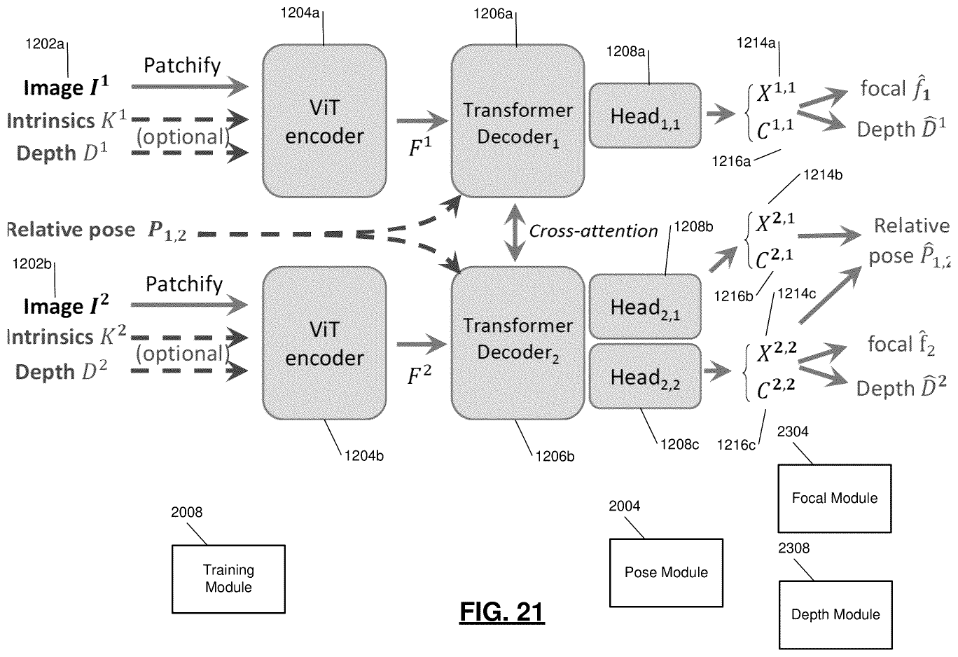

FIG. 21 is a functional block diagram of an example implementation of an extension of the DUSt3R network, which may be referred to as the Pow3R network. Common elements with FIG. 10B are illustrated using common numbering.

In the Pow3R network, relative pose (e.g., 6 degree of freedom, P_{1,2}) of the camera (second camera) that captured image 2 relative to the pose of the camera (first camera) that captured image 1 may be input to the decoders 1206a and 1206b. The decoders 1206a and 1206b generate their respective outputs based on the relative pose.

Additionally or alternatively to inputting the relative pose to the decoders 1206a and 1206b, first intrinsics (K₁) of the first camera that captured the first image may be input to the encoder 1204a. The first intrinsics of the first camera may include, for example, principal point, focal length, and one or more intrinsic parameters of the first camera. In this example, the encoder 1204a generates its output (encoding) based additionally on the first intrinsics.

Additionally or alternatively to inputting the relative pose to the decoders 1206a and 1206b, a first depth map (D₁) of objects in the first image may be input to the encoder 1204a. The first depth map may be dense or sparse. In the example of dense, the first depth map may include a depth from the first camera to the closest object for each pixel. In the example of sparse, the first depth may include a depth from the first camera to the closest object for less than all pixels. In this example, the encoder 1204a generates its output (encoding) based additionally on the first depth map.

In various implementations, one, two, or all of the relative pose, the first intrinsics, and the first depth map may be input.

Additionally or alternatively to inputting the relative pose to the decoders 1206a and 1206b, second intrinsics (K₂) of the second camera that captured the second image may be input to the encoder 1204b. The second intrinsics of the second camera may include, for example, principal point, focal length, and one or more intrinsic parameters of the second camera. In this example, the encoder 1204b generates its output (encoding) based additionally on the second intrinsics.

Additionally or alternatively to inputting the relative pose to the decoders 1206a and 1206b, a second depth map (D₂) of objects in the second image may be input to the encoder 1204b. The second depth map may be dense or sparse. In the example of dense, the second depth map may include a depth from the second camera to the closest object for each pixel. In the example of sparse, the second depth may include a depth from the second camera to the closest object for less than all pixels. In this example, the encoder 1204b generates its output (encoding) based additionally on the second depth map.

In various implementations, one, two, or all of the relative pose, the second intrinsics, and the second depth map may be input.

The Pow3R network also includes an additional regression head 1208c. The regression head 1208c generates an additional pointmap X^{2,2} 1214c and an additional confidence map X^{2,2} 1216c based on the second image. The determination of the pointmap 1214c and the confidence map 1216c may be as discussed above with respect to the pointmaps 1214a-b and the confidence maps 1216a-b. The branches of the Pow3R network are therefore asymmetrical, different than the branches of the DUSt3R network.

The pose module 2004 estimates the relative pose (\hat{P}_{1,2}) of the second camera that captured image 2 relative to the pose of the first camera that captured image 1 based on the pointmap 1214b, the confidence map 1216b, the pointmap 1214c, and the confidence map 1216c.

A focal point module 2304 estimates a focal point \hat{F}₂ of the second camera that captured the second image based on the pointmap 1214c and the confidence map 1216c. A depth module 2308 estimates a depth map \hat{D}₂ of the second image based on the pointmap 1214c and the confidence map 1216c. The focal point module 2304 estimates a focal point \hat{F}₁ of the first camera that captured the \hat{F}₂ image based on the pointmap 1214a and the confidence map 1216a. The depth module 2308 estimates a depth map \hat{D}₁ of the first image based on the pointmap 1214a and the confidence map 1216a. The estimates depth maps may be sparse (less than all pixels) or dense (per pixel).

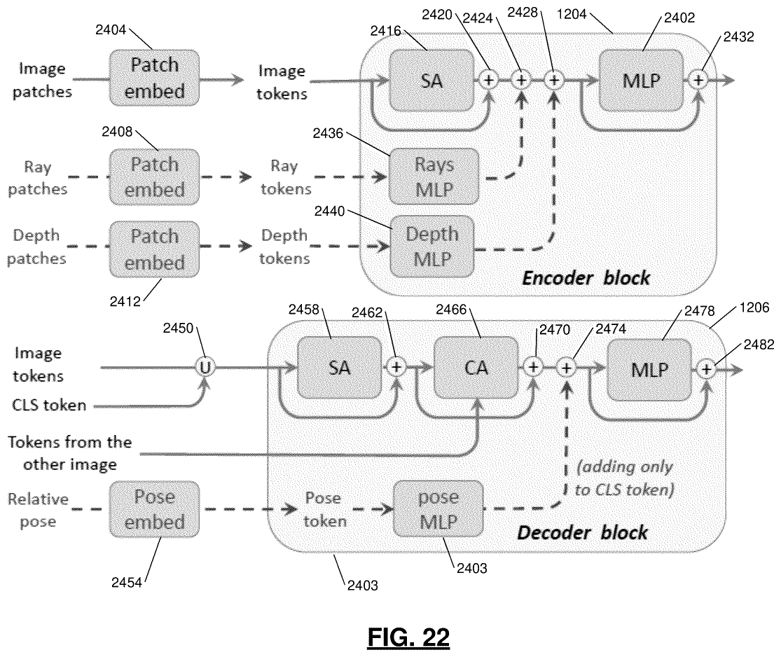

FIG. 22 includes a functional block diagram of an example implementation of an encoder block (e.g., a first encoder block—block 1) of an encoder (e.g., 1204a, 1204b) of the Pow3R network and an example implementation of a decoder block (e.g., a first decoder block) of a decoder (e.g., 1206a, 1206b) of the Pow3R network. While one encoder block is illustrated, the encoder includes W encoder blocks where the output of one encoder block is input to the next encoder block. W is an integer greater than two. For example, the encoder may include 24 encoder blocks (W=24). The encoder blocks may be identical or some of the encoder blocks may be different. For example, some of the encoder blocks may not include the MLP module 2402. In an example, the 1^{st} and 13^{th} encoder blocks may be the same as illustrated, while the other 22 encoder blocks may not include the MLP module 2402. While one decoder block is illustrated, the encoder includes Y decoder blocks where the output of one decoder block is input to the next decoder block. Y is an integer greater than two. For example, the decoder may include 12 decoder blocks (Y=12). The decoder blocks may be identical or some of the decoder blocks may be different. For example, some of the decoder blocks may not include a pose MLP module 2403. In an example, the 1^{st} and 7^{th} decoder blocks may be the same as illustrated, while the other 10 decoder blocks may not include the pose MLP module 2403.

On the top of FIG. 22, as discussed above, the images are patchified (chopped into patches) and images patches. An embedding module 2404 embeds the image patches into respective image tokens. The intrinsics of the camera may be patchified to generate ray patches. An embedding module 2408 embeds the ray patches into respective ray tokens. The depth map of the camera may be patchified to generate depth patches. An embedding module 2412 embeds the depth patches into respective depth tokens.

The encoder block illustrated includes a self attention (SA) module 2416, an adder module 2420, an adder module 2424, an adder module 2428, the MLP module 2402, an adder module 2432, a ray MLP module 2436, and a depth MLP module 2440. As discussed above, the MLP module 2402 may be omitted in one or more of the encoder blocks. If the intrinsics are not input, the ray MLP module 2436 may be omitted. If the depth map is not input, the depth MLP module 2440 may be omitted.

The self attention module 2416 performs self attention across the image tokens. The adder module 2420 adds the image tokens to the output of the self attention module 2416. The ray tokens are input to and processed by the ray MLP 2346. The adder module 2424 adds the output of the ray MLP module 2436 to the output of the adder module 2420. The depth tokens are input to and processed by the depth MLP module 2440. The adder module 2428 adds the output of the depth MLP module 2440 to the output of the adder module 2428. The MLP module 2420 processes the output of the adder module 2428. The adder module 2432 adds the output of the MLP module 2402 to the input of the MLP module 2402 (i.e., the output of the adder module 2428). The output of the adder module 2432 (the output of the encoder block) is input to the next encoder block in place of the image tokens.

On the bottom of FIG. 22, a decoder block is illustrated. The image tokens of that image (e.g., Image 1 in the example of the decoder 1206a) are input along with the CLS token of that image to a union module 2450. The union is output to the decoder block. The tokens of the other image (e.g., Image 2 in the example of the image tokens of image 1 for the example of the decoder 1206a) are also input to the decoder block. In the example of the relative pose being input, an embedding module 2454 embeds the relative pose into a pose token. The pose token is input to the decoder block.

The decoder block includes a self attention (SA) module 2458, an adder module 2462, a cross attention (CA) module 2466, an adder module 2470, an adder module 2474, a MLP module 2478, an adder module 2482, and the pose MLP module 2403. As discussed above, the pose MLP module 2403 may be omitted if the relative pose is not input, and the pose MLP module 2403 may be omitted for one or more decoder blocks. The pose MLP module 2403 processes the pose token.

The self attention module 2458 performs self attention across tokens output by the union module 2450. The adder module 2420 adds the tokens output by the union module 2450 to the output of the self attention module 2458.

The cross attention module 2466 performs cross attention across the tokens output by the adder module 2462 and the tokens of the other image. The adder module 2470 adds the tokens output by the cross attention module 2466 to the tokens output from the adder module 2462. The adder module 2474 adds the output of the pose MLP module 2403 to the output of the adder module 2470. For example only, the adder module 2474 may add the token output of the pose MLP module 2403 to the CLS token.

The MLP module 2478 processes the output of the adder module 2474. The adder module 2482 adds the output of the MLP module 2478 to the output of the adder module 2474. The output of the decoder block (from the adder module 2482) is input to the next decoder block.

The Pow3R network is a novel large 3D vision regression model that is highly versatile in the input modalities it accepts. Unlike feed-forward models that lack any mechanism to use camera or scene priors at test time, the Pow3R network incorporates any combination of auxiliary in formation such as intrinsics, relative pose, and/or dense or sparse depth, alongside input images, within a single network.

The Pow3R network uses a transformer based architecture that leverages powerful pre-training. The lightweight and versatile conditioning (intrinsics, pose, depth) acts as additional guidance for the network to predict more accurate estimates when auxiliary information is available. During training the training module 2008 feeds the Pow3R network with random subsets of modalities at each iteration, which enables the Pow3R network to operate under different sets of one or more of the additional inputs at test and inference time. This in turn provides the Pow3R network with new capabilities, such as performing inference in native image resolution, or point-cloud completion. The Pow3R network provides a high level of performance on 3D reconstruction, depth completion, multi-view depth prediction, multi-view stereo, and multi-view pose estimation tasks. This confirms the effectiveness of the Pow3R network at exploiting all available information.

Building non-task specific models for 3D perception that can perform different 3D vision tasks such as depth estimation, keypoint matching, dense reconstruction or camera pose prediction, is a complex challenging problem.

The Pow3R network is a 3D feed-forward model that uses any subset of priors available, such as camera intrinsics, sparse or dense depth, or relative camera poses. Each modality is injected into the Pow3R network in a lightweight fashion. To allow the Pow3R network to operate under different conditions at test time, random subsets of input modalities are fed to the Pow3R network by the training module 2008 at each training iteration.

As a result, the Pow3R network provides a single model that performs on par with other models when no prior information is available but outperforms it when it exists. The Pow3R network also gains new capabilities as a by-product: for instance, the camera intrinsics input allow to process images whose principal point is far from the center, thus allowing to perform extreme cropping e.g., for performing sliding window inference. The Pow3R network directly outputs the pointmaps of the second image in its coordinate system, allowing faster relative pose estimation. Generally speaking, the Pow3R network: provides a holistic 3D geometric vision model capable of taking any subset (including none) of camera intrinsics, pose and depthmaps with corresponding input images. The Pow3R network provides an important boost in performance over models that are not configured to use priors. By predicting the same pointmaps in two different camera coordinate systems, the Pow3R network can achieve more accurate relative pose estimations, orders of magnitude faster.

The training module 2008 trains the Pow3R network F that can take two input images I¹, I²∈ [symbol] ^{W×H×3} of a given static scene and any subset of auxiliary (prior) information Ω⊆{K₁, K₂, P_{1,2}, D₁, D₂}, in order to regress a 3D reconstruction of the scene. Here, K₁, K₂∈ [symbol] ^{3×3} are camera intrinsics, P_{1,2}∈ [symbol] ^{4×4} denote the relative pose between the two cameras, and D₁, D₂∈ [symbol] ^{W×H} are depth maps with associated masks M₁, M₂∈{0,1}^{W×H} specifying pixels with valid depth data (i.e., masks may be sparse). The network F is configured to regress several pointmaps from which the camera intrinsic and extrinsic parameters as well as the dense depth maps can be extracted for both images as described below.

Regarding the pointmaps, for each pixel (i, j) in an image I, it may be assumed there exists a corresponding single 3D point X_{i,j}, where X∈ [symbol] ^{W×H×3} is a pointmap. Given camera intrinsics K and a depthmap D, the network computes X_{i,j}=K⁻¹[iD_{i,j}, jD_{i,j}, D_{i,j}] in the camera coordinate system.

In the following, X_{n,m} may denote the pointmap of image expressed in the coordinate system of camera Iₘ. To swap the coordinate system from camera Iₖ to camera Iₘ, X^{n,k}=P_{m,k}X^{n,m} is given where

$${P}_{m , k} = {P}_{k} {P}_{m}^{- 1} .$$

As discussed above, the images are encoded and then decoded with a ViT backbone into pointmaps, from which focals, depthmaps and relative pose can be determined. The Pow3R network uses optional inputs (priors) to guide the regression with prior knowledge about the camera intrinsics and depth fed into the encoders) and the pose (into the decoder).

The Pow3R network is configured to regress two 3D pointmaps X^{1,1}, X^{2,1} given solely two unposed and uncalibrated input images. The Pow3R network includes specific modules to incorporate any subset of extra information such as camera intrinsics, camera poses and depthmaps. The Pow3R network predicts an additional pointmap X^{2,2}, which represents the pointmap of image I2 in its own coordinate system. Predicting three pointmaps offers further capabilities, such as the possibility of recovering all information about both cameras in a single forward pass.

The encoders 1204 may encode both images independently. In addition to I, the encoders can receive auxiliary information about intrinsics K and depth D for each image as discussed above. For the two input images I¹, I² and their respective auxiliary information Ω₁∈σ({K₁, D₁}), Ω₂∈σ({K₂, D₂}), where σ denotes the set of all subsets, the encoder processes the information in a Siamese manner:

$${F}^{1} = Encoder ( {I}^{1} , {Ω}_{1} ) , {F}^{2} = Encoder ( {I}^{2} , {Ω}_{2} ) . \qquad ( I )$$

The Pow3R network includes the two decoders 1206a-b, each with its corresponding head, one predicting X^{1,1} and the other one estimating X^{2,1} and X^{2,2}. Both decoders communicate via cross-attention between their own tokens and the outputs of the previous block of the other decoder. Each decoder may receive the relative pose P_{1,2} as additional input or not. Consider providing the auxiliary information Ω_{D}∈σ({P_{1,2}}) at the i-th block of both decoders:

$${G}_{i}^{1} = {DecoderBlock}_{i}^{1} ( {G}_{i - 1}^{1} , {G}_{i - 1}^{2} , {Ω}_{D} ) \qquad ( II )$$

$${G}_{i}^{2} = {DecoderBlock}_{i}^{2} ( {G}_{i - 1}^{2} , {G}_{i - 1}^{1} , {Ω}_{D} )$$

After B decoder blocks in each branch, the head regresses the pointmaps and their associated confidence maps:

$${X}^{1 , 1} , {C}^{1 , 1} = {Head}^{1} ( {G}_{B}^{1} ) \qquad ( III )$$

$${X}^{2 , 1} , {X}^{2 , 2} , {C}^{2 , 1} , {C}^{2 , 2} = {Head}^{2} ( {G}_{B}^{2} )$$

The training module 2008 may train the Pow3R network in a supervised manner based on minimizing a distance between ground-truth and predicted pointmaps in a scale-invariant manner, allowing the Pow3R network to train on multiple datasets with various scales.

The regression loss between predicted and ground-truth pointmaps (respectively X^{n,m} and \hat{X}^{n,m}) at pixel (i, j) is defined as

$${ℒ}_{i , j}^{r e g r} ( n , m ) = ‖ \frac{{X}_{i , j}^{n , m}}{{z}_{m}} - {\hat{X}}_{i , j}^{n , m} / {\hat{z}}_{m} ‖$$

where zₘ, \hat{z}ₘ serve as scale normalizer. That is, zₘ is the average norm of all valid 3D points expressed in coordinate system of image I^{m}, i.e. z₁=norm(X^{1,1}∪X^{2,1}2,1), z2=norm(X^{2,2}) and likewise for \hat{z}₁, \hat{z}₂, with norm(X)=mean({∥X_{i,j}∥|i,j∈D_{X}}) and D_{X} the set of valid pixels.

The Pow3R network jointly learns to predict a confidence level

$${C}_{i , j}^{n , m}$$

of each pixel (i, j). The confidence-aware regression loss for a given pointmap X^{n,m} can be expressed as the 3D regression loss [symbol] ^{regr} weighted by the confidence map:

$${ℒ}^{conf} ( n , m ) = {\sum }_{i , j ∈ D} {C}_{i , j}^{n , m} {ℒ}^{r e g r} ( n , m ) - α log {C}_{i , j}^{n , m} \qquad ( IV )$$

This loss penalizes the Pow3R network less when the prediction is not accurate on harder areas, encouraging the model to extrapolate. The final loss based upon which the training module 2008 adjusts parameters of the Pow3R network (e.g., to minimize the final loss) during training may be expressed as

$$ℒ = {ℒ}^{conf} ( 1 , 1 ) + {ℒ}^{conf} ( 2 , 1 ) + {βℒ}^{conf} ( 2 , 2 ) \qquad ( V )$$

where β is a predetermined hyper-parameter and may be set to for example β=1.

The knowledge of auxiliary information can significantly enhance 3D predictions at test and inference time. The Pow3R network leverages up to five different modalities, which include two intrinsics, two depthmaps for the images, and the relative pose P12. To condition the output on it, the Pow3R network embeds the auxiliary information using dedicated MLPs and then injects these embeddings at different points in the pipeline.

In an example, denoted as ‘embed’, the Pow3R network may add the auxiliary embeddings to the token embeddings before the first transformer block. In another example, denoted as ‘inject-n’, the Pow3R network may include dedicated MLPs for each modality in a subset of n transformer blocks, such as shown in FIG. 22. The ‘inject-1’ example may perform better than the ‘embed’ example and similarly with ‘inject-n’, where n>1.

Here will be described how to determine the embeddings for each specific modality.

For the intrinsics, the embedding module 2408 may generate camera rays from the intrinsic matrix K∈ [symbol] ^{3×3}, thereby establishing a direct correspondence between RGB pixels and rays. The ray at pixel location (i, j) is determined by the embedding module 2408 as K⁻¹[i, j, 1] and encodes the viewing direction of that pixel with respect to the current camera pose. This allows processing of non-centered crops and hence performance of inference in higher image resolutions. Similarly to the images, the rays may be patchified, and the embedding module 2408 may embed dense rays and provide them to the encoder.

For depthmaps/Point Clouds, given a depthmap D and its sparsity mask M, the embedding module 2402 may normalize D′=D/norm(D) to handle any depth ranges at train and test time. Similar to the images and rays, the Pow3R network (e.g., a patching module) may patchify the stacked maps [D′, M]∈ [symbol] ^{W×H×2}, and the embedding module 2412 may embed the patches into patch embeddings, which are then fed to the encoder. By jointly patchifying the depth and its valid masks, the Pow3R network is configured to work with any level of sparsity.

For the camera pose, given the relative pose P₁₂=[R₁₂|t₁₂], the Pow3R network may normalize the translation scale as t′12=t12/∥t12∥ since the output may be unscaled. Unlike depthmaps or camera intrinsics, the camera pose cannot be expressed as a dense pixel map. Rather, camera pose affects the whole pixels between two images, so the embedding is instead added to the global CLS token of both decoders by the adder 2474.

The top of FIG. 22 illustrates the injection of optional intrinsics and depth into the encoder. Intrinsics are encoded into ray patches, sparse depth is patchified. Each of these modalities goes into a block-specific MLP and are tokenwise added in the middle of the transformer block. The bottom of FIG. 22 illustrates injection of optional relative pose into the decoder. The relative pose is fed to a first embedding layer followed by a MLP. This token is added to the CLS token of the decoder after the self-attention and cross-attention, but before the MLP. Experiments show that injection in the first block only suffices.

Regarding downstream tasks for the depthmaps, in the pointmap representation, the z-axis of X^{1,1}, X^{2,2} directly corresponds to the depth maps of the first and second image, respectively. The Pow3R network can handle high resolution crops natively given camera intrinsics of the crop, as these provide the crop position information (i.e. via focal length and principal point). The Pow3R network can thus perform prediction in a sliding window fashion, yielding predictions matching any target resolution by stitching. Note that that prediction for each crop may have a different scale, by design, and may not be stitched directly. In this case, the Pow3R network may determine the median scale factor in overlapping areas, and the Pow3R network may confidence-based blend the overlapping regions without further post-processing.

Regarding focal estimation, the Pow3R network may determine focals for both input images from pointmap X^{1,1} and X^{2,2} such as with the Weiszfeld fast iterative solver. The Weiszfeld fast iterative solver is described in F. Plastria, The Weiszfeld Algorithm: Proof, amendments, and extensions, Foundations of Location Analysis, 2011.5, which is incorporated herein in its entirety. The Pow3R network may infer (I2, I1) in a single pass.

Regarding relative pose estimation, the Pow3R network predicts the relative pose directly, such as by Procrustes alignment to get the scaled relative pose P*=[R*|t*] between X^{2,2} and X^{2,1} as it predicts the pointmaps of the second image in two different camera coordinates.

$$R * , t * = arg {min}_{σ , R , t} {\sum }_{i , j} \sqrt{{C}_{i , j}^{2 , 2} {C}_{i , j}^{2 , 1}} {‖ ( σ {RX}_{i , j}^{2 , 2} + t ) - {X}_{i , j}^{2 , 1} ‖}^{2} \qquad ( VI )$$

Procrustes alignment may be sensitive to noise and outliers. However, this is magnitudes computationally faster than RANSAC with PnP.

Regarding global alignment, the network F predicts pointmaps for image pairs. To align all predictions in the same world coordinate system, the global aligner may operate as described above and minimize a global energy function to find per-camera intrinsics, depthmaps and poses that are consistent with all the pairwise predictions. Results of the optimization are global scene point-clouds, which can for instance serve for multi-view stereo estimation.

During training, the training module 2008 feeds the Pow3R network with annotated image associated with random subsets of auxiliary information, the goal being for the Pow3R network to learn to handle any situation at test time. For each pair, the training module 2008 may chose a random number m of modalities with uniform probability, and then randomly select the m modalities likewise. The training module 2008 may randomly sparsify depthmaps. When giving intrinsics, the training module 2008 may perform aggressive non-centered cropping with a predetermined probability (e.g., 50%), so that the network learns to perform high-resolution inference.

The training may be using training datasets that include indoor and outdoor scenes, as well as real and synthetically generated images. The training module 2008 may first train the Pow3R network with a resolution of 224px, and then finetune it at a resolution of 512px with variable aspect-ratio.

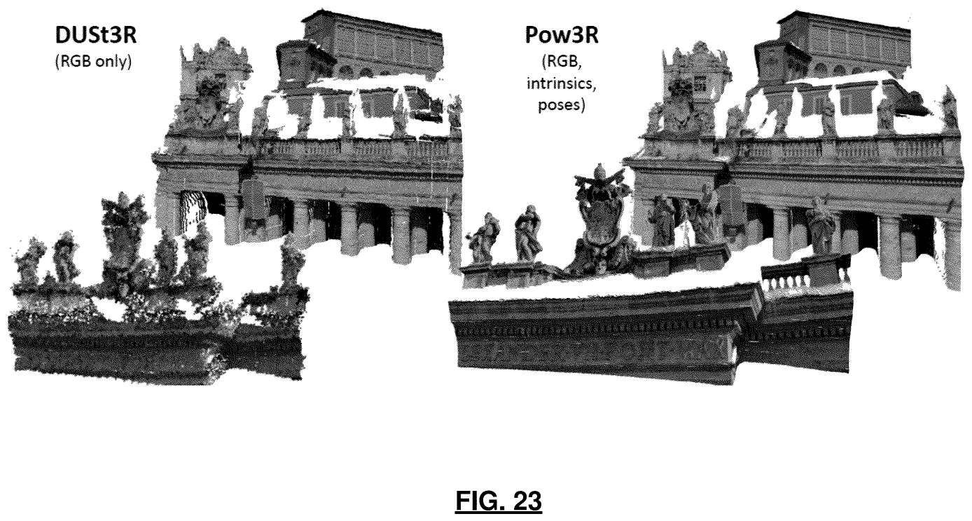

FIG. 23 illustrates examples of reconstructions of a scene. On the left in FIG. 23 is an illustration produced by the DUSt3R network based on images. On the right in FIG. 23 is an illustration produced by the Pow3R network based on images, intrinsics, and camera poses. As illustrated, the output of the Pow3R network may be more accurate and lifelike.

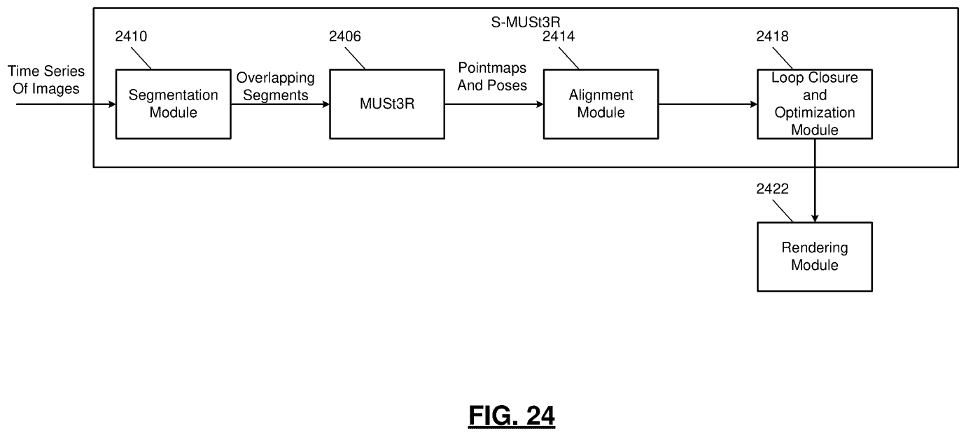

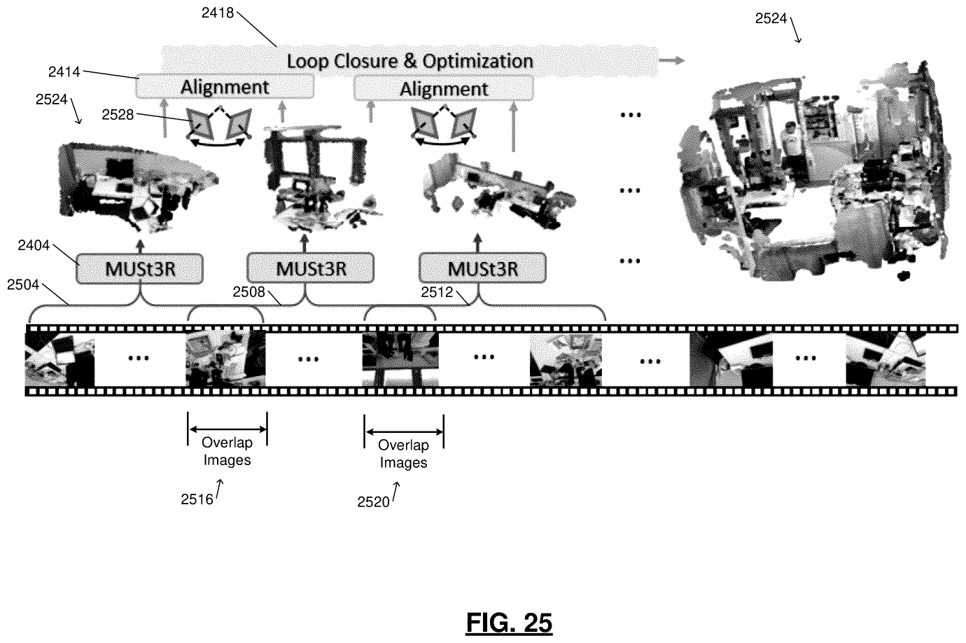

FIGS. 24-25 include functional block diagrams of a sliding version of the MUSt3R network, which may be referred to as S-MUSt3R. The MUSt3R network utilizes memory as described above, such as in conjunction with FIGS. 18-20. With large strings of images, however, such as video of a scene to be reconstructed, memory use may be high. Some GPUs may reach memory limits if more than a few hundred images are input.

The S-MUSt3R network is a sliding window extension of the MUSt3R network for long sequences of images (e.g., N>400), such as video of a scene to be reconstructed. The S-MUSt3R network involves segmenting input images into overlapping segments of images, reconstructing each segment independently, then aligning and stitching together the reconstructions. Loop closure and optimization may also be performed. The MUSt3R network described above is used, and the segments are individually input to the MUSt3R network. No retraining of the MUSt3R network may be performed. The S-MUSt3R network addresses drift and scalability without requiring a more sophisticated network to be used. The S-MUSt3R network provides a globally consistent 3D reconstruction system that is simple, efficient, and applicable to downstream tasks, such as robotic navigation. The S-MUSt3R network leverages the ability of the MUSt3R network to make predictions in the metric space.

The S-MUSt3R network extends the MUSt3R network to large-scale scenes, without requiring camera calibration. The S-MUSt3R network uses a segment-process-stitch approach that mitigates memory constraints on long sequences of input images.

The S-MUSt3R network may use a lightweight loop closure and pose optimization that allows the S-MUSt3R network to achieve high performance in uncalibrated settings without using a graph-based backend, which would be more computationally inefficient.

By segmenting the input images into overlapping segments, the align-and-stitch approach provides at least the following improvements: pose graph where segments are nodes (sequence adjacent segments and loop segments for loop closure) and edges are constrained by transforms between segments; better confidence estimation using depth estimation consistency; a double alignment between segments using both pointmaps and poses of the corresponding region; and an additional reconstruction of the scene location where the loop occurs to bridge distant segments.

As illustrated in FIG. 24, the S-MUSt3R network includes the MUSt3R network 2406, which is discussed in detail above (e.g., in conjunction with FIGS. 18-20). A segmentation module 2410 receives a time series of images (e.g., video) including a scene. The time series of images may include more than a predetermined number of images captured at respective times, such as approximately 500 images or more. The segmentation module 2410 segments the time series of images into overlapping segments of the images. Each segment includes a first predetermined number of images that are included in at least one adjacent (last or next) segment. For example, FIG. 25 illustrates segments of images 2504, 2508, and 2512. The first predetermined number of overlapping images is illustrated by 2516, and the overlapping images 2516 are included in both the segment 2504 and the segment 2508. Similarly, overlapping images 2520 are included in both the segment 2508 and the segment 2512. As such, the segment 2508 includes the first predetermined number of overlapping images 2516 that are also included in the segment 2504 and the first predetermined number of overlapping images 2520 that are also included in the segment 2512.

The segmentation module 2410 may segment the time series into approximately equal lengths (e.g., within 1 or 2 images of each other) or segment the time series into the same predetermined number (e.g., 100) of images. In the example of segmenting the time series into the predetermined number of images, a final one of the segments may include less than the predetermined number of images. For example, if the time series includes 943 images and the predetermined number of 100 images is used, the initial segments may each include 100 images, but the final segment will include less than 100 images.

The segmentation module 2410 inputs the segments to the MUSt3R network 2406 individually. Based on an input segment, the MUSt3R network 2406 generates a pointmap and a pose of the camera that captured the segment of the time series. FIG. 25 includes an example pointmap 2524 generated based on the segment 2504. FIG. 25 also illustrates an example pose 2528 of the camera generated based on the segment 2504. The MUSt3R network 2406 generates a pointmap and a pose for each segment based on the images of that segment.

An alignment module 2414 (FIG. 24) aligns the pointmaps and the poses. The alignment module 2414 performs the alignment in order of the segments. The pointmap and the pose of the first segment 2504 are used as a common coordinate system in various implementations. For example, first the alignment module 2414 aligns the pointmap of the segment 2508 to the pointmap of the segment 2504 and the pose of the segment 2508 to the segment 2504. The alignment of the pose may involve determining a translation (e.g., 3 degrees of freedom) and a rotation (e.g., in 3 degrees) of the pose of the segment 2508 relative to the pose of the segment 2504. For the next segment 2512 after the segment 2508, the alignment module 2414 aligns the pointmap of the segment 2512 to the pointmap of the segment 2508 and the pose of the segment 2512 to the segment 2508. The alignment of the pose may involve determining a translation (e.g., 3 degrees of freedom) and a rotation (e.g., in 3 degrees) of the pose of the segment 2512 relative to the pose of the segment 2508. In combination with the translation and rotation of the pose of segment 2508 with that of the segment 2504, alignment with the segment 2504 can be achieved by the alignment module 2414. This process continues for each successive segment to ultimately align with the first segment 2504. The alignment module 2414 may for example perform Prosecutes alignment as discussed above.

A loop closure and optimization module 2418 (FIG. 16) forms loops between the pointmaps and optimizes the pointmaps as described further below. A rendering module 2422 renders the environment in 3D using the output of the loop closure and optimization module 2418. An example of a 3D rendering generated based on the pointmaps of the segments is illustrated by 2524 in FIG. 25.

The MUSt3R network 2406 extends pair-wise DUSt3R to an arbitrary number of images and maps them in 3D pointmaps in a first frame's coordinate system. The MUSt3R network 2406 uses a multi-layered memory, which includes patches of previously seen images, such as described above with respect to FIG. 19. To control the memory size growing linearly with the number of images, The MUSt3R network applies a special strategy to select memory tokens using the image discovery rate; the MUSt3R network 2406 leverages a running memory and updates 3D scene of current observations on-the fly.

For an input image I of size H×W, the MUSt3R network 2406 outputs a pointmap X∈R^{3×H×W}, confidence map C∈R^{H×W} and depth map d∈R^{H×W}. The MUSt3R network 2406 is able to process hundreds of images, but hits the memory limits on longer sequences.

As described above, the segmentation module 2410 therefore segments a longer sequence of images into overlapping segments. The S-MUSt3R network includes modifications to the aligning, stitching and loop closure in order to ensure a robust 3D reconstruction.

The S-MUSt3R network may be described is a sliding (window) based version of the MUSt3R network 2406 running over a long monocular image sequence. First, the segmentation module 2410 splits the sequence (time series of images) into overlapping segments; second, the MUSt3R network 2406 processes the segments one by one; third, the alignment module 2414 aligns the results of the segments to express each output in the first frame's frame of |reference. The loop closure and optimization module 2418 corrects the final representation by detecting segment-wise loops, building a pose graph where segments are nodes and the edges are constrained by alignments, and after performs pose graph optimization. The S-MUSt3R network 2406 benefits from local reconstruction of the results of the segments from the MUSt3R network 2406 while ensuring global accuracy when fast and efficient collecting segments in the full dense scene pointmap.

An input sequence of N images,

$${\{ {I}_{i} \}}_{i = 1}^{N}$$

is first segmented by the segmentation module 2410 into overlapping segments of the images. The segments may all have the same length l (e.g., except the last segment) and the overlap size p. The first segment S₁ includes frames from 1 to l, the second segment S₂ includes frames from l−p+1 to 2*l−p, and so on.

The MUSt3R network 2406 may be trained using a confidence-aware loss and predicts a confidence score for each pixel in the images. The segment alignment performed by the alignment module 2414 is aware of the possibility of 3D outliers, and accurate confidence maps are beneficial for filtering the outliers out. The S-MUSt3R network benefits from segment overlaps as an additional source of information for confidence estimation.

The same image gets different context in adjacent segments, and the MUSt3R network 2406 may generate a different depth estimation for the same image. Inconsistency in depth estimation can decrease accuracy of segment alignment.

To align 3D pointmaps of two overlapping segments the alignment module 2414 uses both the confidence and depth maps for the segments. The alignment module 2414 trusts points with higher confidence and down-weight points with inconsistent depth across the segments (e.g., in the overlapping portions).

Generally stated, given confidence values cᵢₚ, cⱼₚ and depth values dᵢₚ, dⱼₚ for pixel p of the image I present in overlapping segments Sᵢ and Sⱼ, the alignment module 2414 may modulate the confidences by penalizing depth disagreements with weight w. The alignment module 2414 may determine the weight (w) for a pixel using th|e equation

$$w = \frac{{c}_{ip} \cdot {c}_{jp}}{1 + \vert {d}_{ip} - {d}_{jp} \vert} \qquad ( Z )$$

where cᵢₚ, cⱼₚ are confidence values for the pixel and dᵢₚ, dⱼₚ are depth values for the pixel. The alignment module 2414 may update the confidence values cᵢₚ, cⱼₚ based on the weight, such as using the equations c′ᵢₚ=w·cᵢₚ and c′ⱼₚ=w·cⱼₚ.
The updated confidence values are used to generate updated confidence maps including the confidence values per pixel. The updated confidence maps may be denoted Cᵢ, Cⱼ.

Stitching local pointmaps in the global one involves the accurate estimation of the segment alignments in order to express all 3D point coordinates in the first image's frame of reference. In various examples, the alignment module 2414 may estimate the transforms using SIM(3) Lie groups as discussed further below. SIM(3) Lie groups are described, for example, in K. Deng, et al., VGGT-Long: Chunk it, Loop it, Align it—Pushing VGGT's limits on Kilometer-scale long RGB sequences, arXiv preprint arXiv:2507.16443, 2025, which is incorporated herein in its entirety.|

In the following, consider the alignment between two segments as belonging to transform group T, where T is one of three Lie groups of increasing complexity, SIM(3), Affine(3) or SL(4). SIM(3) group includes rotations, translations, and uniform scaling. Affine(3) group includes in addition to SIM(3) non-uniform scaling and shearing. SL(4) group includes translations, scaling, and projective warping. Higher expressive power however comes with a higher computational cost. Testing has shown that SIM(3) represents a globally best performance-speed compromise for the S-MUSt3R network.

The MUSt3R network 2406 processes the segments independently. The processing may be described by, given an segment Sₖ, the MUSt3R network 2406 outputs a 3D pointmap Xₖ, confidence map Cₖ, per-frame depth estimation dₖ, completed with segmentwise consistent camera poses pₖ. The MUSt3R network's 2406 confidence as well the frame-based depth estimation may be used by the alignment module 2414 to robustly align the overlapping segments. For two adjacent segments, Sₖ and Sₖ₊₁, the alignment module 2414 identifies a set of 3D point correspondences (Xⁱₖ, Xⁱₖ₊₁) and confidences (Cⁱₖ, Cⁱₖ₊₁) within their overlapping region. To robustly estimate the transformation T_{k, k+1}∈T that aligns segment Sₖ₊₁ to segment Sₖ, the alignment module 2414 may use, for example, Iteratively Reweighted Least Squares (IRLS) optimization. An objective of the optimization may be to minimize the following robust cost function

$${T}_{k , k + 1}^{x} = arg {min}_{T ∈ 𝒯} {\sum }_{i} ρ ( {‖ {X}_{k}^{i} - {TX}_{k + 1}^{i} ‖}_{2} ) \qquad ( Y )$$

where ρ(⋅) is the Huber loss function which down-weights the influence of outliers. The IRLS procedure solves this non-linear problem by iteratively minimizing a weighted sum of squared errors.

In addition to aligning adjacent segments by 3D correspondences, the alignment module 2414 may align segments Sₖ and Sₖ₊₁ by another one of the MUSt3R network's|2404 output, namely the camera |poses (pⁱₖ, pⁱₖ₊₁), within overlapping portion. In equation (Y), the pointmap X^{j}i may replace the set of estimated camera poses p^{j}i Due to a much smaller size, the inference of the alignment from camera poses may be negligible with respect to pointmaps,

$${T}_{k , k + 1}^{p} = arg {min}_{T ∈ 𝒯} {\sum }_{i} ρ ( {‖ {P}_{k}^{i} - {TP}_{k + 1}^{i} ‖}_{2} ) \qquad ( X )$$

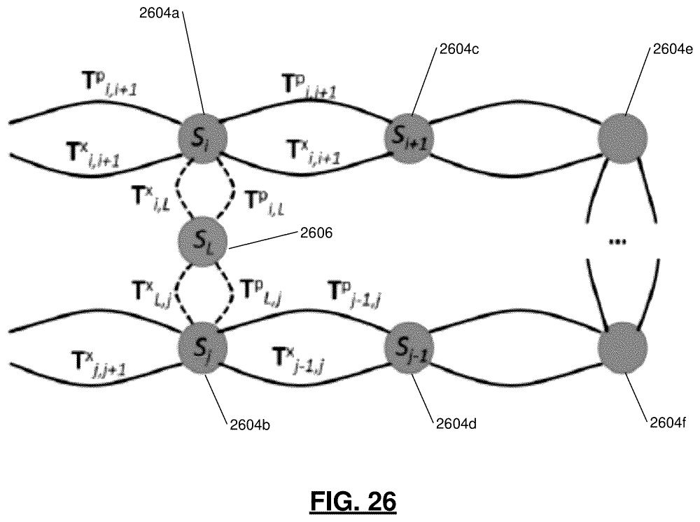

Therefore, for two adjacent segments Sₖ and Sₖ₊₁, the alignment module 2414 determines two transform estimations, T^{x}_{k, k+1} and T^{p}_{k, k+1}, inferred from pointmaps and camera poses, respectively. In the pose graph, they form two edges connecting nodes Sₖ and Sₖ₊₁. Examples are illustrated by the nodes (collectively 2604) in FIG. 26. FIG. 26 is an example of a pose graph where segments are nodes 2604. Nodes 2604 are for sequence segments and an extra node 2606 is illustrated for loop closure. Edges are constrained by pose-driven and pointmap-driven alignments.

Unlike SIM(3) and Affine(3) groups, aligning segments with transforms from SL(4) group may involve the alignment module 2414 estimating a relative homography matrix between the segments. For example, the alignment module may estimate the relative homography matric using h-solver from VGGT-Slam, which is described in D. Maggio, et al., VGGT-Slam: Dense RGB SLAM optimized on the SL(4) manifold, arXiv preprint, arXiv: 2505.12549, 2025, which is incorporated herein in its entirety. While the use of h-solver is provided, the present application is also applicable to other ways of determining the relative homography matrix.

Regarding the loop closure and optimization module 2418, note that long input sequences may result in the drift accumulation. The loop closure and optimization module 2418 removes the drift by detecting and closing loops across the entire sequence. This process involves finding visual content shared by non-adjacent segments and robustly estimating the transform T∈ [symbol] between them. First, the loop closure and optimization module 2418 reuses output of the encoder of the MUSt3R network 2406 which generates patch features for any image I in the sequence. The loop closure and optimization module 2418 average-pools the patch features to obtain a compact global feature vector f which captures the scene geometry in the image. The loop closure and optimization module 2418 identifies loop closure candidates based on the global image descriptors.

For example, the loop closure and optimization module 2418 may create and maintain KDTree( ) structure D of image descriptors; and for each descriptor, the loop closure and optimization module 2418 may perform an efficient nearest neighbor search in D to find other images with high similarity (e.g., similarity score>predetermined value). A pair of distant images (I, I′), I∈Sᵢ, I′∈Sⱼ, |i−j|>2 (2604a and 2604b) forms a potential loop closure if their similarity score is greater than a threshold σₛᵢₘ (a predetermined value). Two segments with at least kₘᵢₙ=3 loop closure candidates form a loop. For validated loop pairs (I, I′), the loop closure and optimization module 2418 generates an additional reconstruction of the scene location where the loop occurs. The loop closure and optimization module 2418 forms a new segment S_{L} 2606 by concatenating images surrounding images I∈Sᵢ 2604a and images I′∈Sⱼ 2604b. This segment S_{L} 2606 includes distant views of the same scene location and overlaps with segments Sᵢ 2604a and Sⱼ 2604b. By processing the segment S_{L} 2606 by the MUSt3R network 2406, this additional local reconstruction complements the sequential processing of adjacent segments and provides S-MUSt3R with a more diverse, time-dispersed perspective, enabling a more robust scene reconstruction.

The 3D pointmap of segment S_{L} 2606 is then aligned by the alignment module 2414 with the pointmaps of the corresponding segments Sᵢ 2604a and Sⱼ 2604b. The loop closure and optimization module 2418 may close the loop in the pose graph by chaining the alignments through the new segment S_{L} 2606, such as illustrated in FIG. 25. The alignment module 2414 determines transforms to align segment Sᵢ 2604a and segment S_{L} 2606, then S_{L} 2606 and Sⱼ 2604b. Similarly to the processing of adjacent segments, the alignment module 2414 determines the pose graph with two transforms, T_{xi,L} and T_{pi,L}, which align Sᵢ 2604a and S_{L} 2606, and two transforms, T_{xL,j} and T_{pL,j} which align S_{L} 2606 and Sⱼ 2604b. They provide additional geometric constraints for the global optimization by bridging the two distant segments through an additional local 3D reconstruction. The same may be performed for other pairs of nodes, such as 2604c and 2604d, and 2604e and 2604f.

Once the pose graph is completed (e.g., once the last segment is processed), the loop closure and optimization module 2418 may globally optimize all transforms in the pose graph. The pose graph includes adjacent and loop segments; built segment-wise, it is much smaller in the number of nodes and edges than complex frame-based factor graphs. The loop closure and optimization module 2418 may perform the optimization based on minimizing an objective function including of two types of geometric constraints: sequential constraints from adjacent segments and loop closure constraints from non-adjacent segments.

This non-linear least-squares problem is solved by the loop closure and optimization module 2418, such as using the Levenberg-Marquardt (LM) algorithm. By blending Gauss-Newton with gradient descent, the LM algorithm redistributes error over all nodes so that all constraints are satisfied as much as possible. The LM algorithm operates segment-wise and converges in few iterations, due to a small graph size.

In various implementations, the predetermined length of the segments l may be 60 images, the overlap p may be 30 images (15 from each segment), and SIM(3) transform groups may be used. In various implementations, the cosine similarity threshold σₛᵢₘ may be 0.95 for similarity values ranging between 0 (for low similarity) and 1 (for high similarity).

The S-MUSt3R network performs comparability to other baselines on various datasets and has a relatively low average error. This illustrates the ability to extend the MUSt3R network 2406 to multiple sequences instead of a simple pipeline of segmenting the input sequence and stitching local pointmaps. The S-MUSt3R network generates more accurate camera pose estimation with lower pose and angular errors than other baselines using the same segmentation and overlap parameters. For robotic navigation collection of images, the S-MUSt3R network can recover robot tracks thanks to the segment overlaps and loop closures.

In various implementations, the segments l may be 20-200 images, and the overlap p may be l/2. Segmenting the input sequence into longer segments and stitching fewer pointmaps help to reduce average angular error and pose error.

Use of SIM(3) transform groups may improve performance relative to other transform groups. SIM(3) consistently demonstrates its strength by delivering fast and reliable estimates of both pointmaps and camera poses. For larger lengths of segments, computational cost for other types of transform groups may be substantially higher than SIM(3). The S-MUSt3R network provides a low scale estimation error on various different datasets.

The loop closure and optimization decreases average position error (APE) and average angular error (AEE) on various datasets. Estimating two alignments, one from pointmaps and one from camera poses, is also beneficial and reduces error.

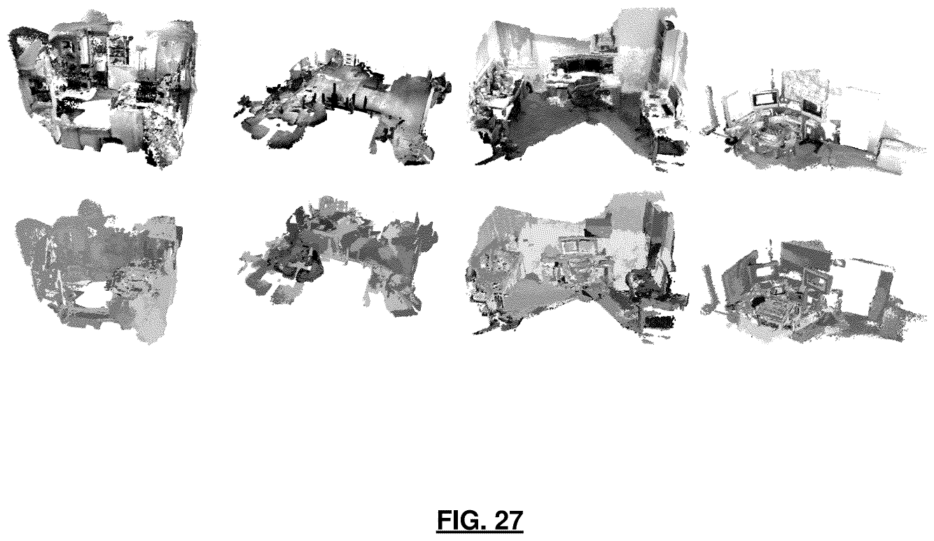

FIG. 27 includes examples of 3D reconstructions generated by the rendering module 2422 based on the output of the S-MUSt3R network. the top row includes 3D reconstructions using the original RGB colors in the images, and the bottom row includes segment pointmaps with different colors.

The stitching performed by the rendering module 2422 may have a dependence on the quality of local reconstructions produced by the S-MUSt3R network. The S-MUSt3R network may mitigate errors however by leveraging the overlapping portions of the segments to filter out inaccuracies.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A computer-implemented method for reconstructing a scene in three dimensions from a plurality of images acquired using an imaging device, comprising:
receiving three or more images without receiving extrinsic or intrinsic properties of the imaging device; and
processing the three or more images using a neural network, including an encoder and a single Siamese decoder, to generate three or more pointmaps of the scene that correspond to the three or more images and that are aligned in a common coordinate frame,
wherein each pointmap is a one-to-one mapping between pixels of one of the three or more images and three-dimensional points of the scene, and
wherein the neural network further includes memory used by the single Siamese decoder in the generation of the three or more pointmaps.

2. The computer-implemented method of claim 1 wherein the single Siamese decoder shares weights across the three or more images.

3. The computer-implemented method of claim 1 wherein the neural network further includes a Siamese head configured to generate the three or more pointmaps.

4. The computer-implemented method of claim 1 further comprising linearly projecting outputs of the encoder and inputting the linearly projected outputs to the decoder.

5. The computer-implemented method of claim 4 further comprising adding a learnable embedding to the linearly projected outputs and inputting to the decoder the linearly projected outputs and the learnable embedding.

6. The computer-implemented method of claim 1 wherein the memory is selectively updated with information from one or more of the three or more images upon determining that the one or more of the three or more images includes a new part of the scene or a different viewpoint of the scene.

7. The computer-implemented method of claim 1 further comprising selectively updating the memory for a layer of the decoder at a time based on a concatenation of (a) the memory for the layer at a last time and (b) an input to the layer at the time.

8. The computer-implemented method of claim 1 further comprising feeding back an input to a last layer of the decoder to an input of a layer of the decoder that is arranged before the last layer of the decoder.

9. The computer-implemented method of claim 1 further comprising feeding back an input to a last layer of the decoder to inputs of all layers of the decoder that are arranged before the last layer of the decoder.

10. The computer-implemented method of claim 1 wherein the decoder includes at least three decoder layers.

11. The computer-implemented method of claim 1 wherein:
the receiving three or more images includes receiving a time series of images including more than three images; and
the computer-implemented method further includes:
segmenting the time series of images into segments of the images, each of the segments including a predetermined number of images that are also included in at least one other one of the segments,
processing the segments using the neural network to generate pointmaps of the scene that correspond to the segments.

12. The computer-implemented method of claim 11 further comprising aligning the pointmaps of the segments.

13. The computer-implemented method of claim 12 wherein the segmenting includes segmenting the time series of images into segments each including a second predetermined number of the images of the time series, wherein the predetermined number is less than the second predetermined number.

14. The computer-implemented method of claim 13 wherein the predetermined number is one-quarter of the second predetermined number.

15. The computer-implemented method of claim 11 further comprising aligning the pointmaps in the common coordinate frame.

16. The computer-implemented method of claim 15 wherein the aligning includes aligning the pointmaps based on poses of the imaging device for the segments, respectively.

17. The computer-implemented method of claim 11 further comprising:
creating a structure of image descriptors for the segments;
for each image descriptor, performing a nearest neighbor search in the structure;
determining similarity scores between pairs of images in the segments;
identifying pairs of images with similarity scores that are greater than a predetermined value;
identifying two of the segments as a loop based on the two of the segments having at least a third predetermined number of the pairs with similarity scores greater than the predetermined value;
forming a new segment based on first ones of the images surrounding the pairs of images; and
processing the new segment using the neural network to produce a new pointmap of the scene that corresponds to the new segment.

18. The computer-implemented method of claim 17 further comprising aligning the new pointmap with the pointmaps in the common coordinate frame.

19. The computer-implemented method of claim 18 wherein the alignment includes aligning based on poses of the imaging devices.

20. The computer-implemented method according to claim 1, wherein the three or more images are overlapping segments of a time series of images.

21. A system for reconstructing a scene in three dimensions from a plurality of images acquired using an imaging device, comprising:
one or more processors; and
memory including code that, when executed by the one or more processors, perform to:
receive three or more images without receiving extrinsic or intrinsic properties of the imaging device; and
process the three or more images using a neural network including an encoder and a single Siamese decoder, to generate three or more pointmaps of the scene that correspond to the three or more images and that are aligned in a common coordinate frame,
wherein each pointmap is a one-to-one mapping between pixels of one of the three or more images and three-dimensional points of the scene, and
wherein the neural network further includes memory used by the single Siamese decoder in the generation of the three or more pointmaps.

22. The system of claim 21 wherein the single Siamese decoder shares weights across the three or more images.

23. The system of claim 21 wherein the neural network further includes a Siamese head configured to generate the three or more pointmaps.

24. The system of claim 21 wherein the code, when executed by the one or more processors, further performs to linearly project outputs of the encoder and input the linearly projected outputs to the decoder.

25. The system of claim 24 wherein the code, when executed by the one or more processors, further performs to add a learnable embedding to the linearly projected outputs and input to the decoder the linearly projected outputs and the learnable embedding.

26. The system of claim 21 wherein the memory is selectively updated with information from one or more of the three or more images upon determining that the one or more of the three or more images includes a new part of the scene or a different viewpoint of the scene.

27. The system of claim 21 wherein the code, when executed by the one or more processors, further performs to selectively update the memory for a layer of the decoder at a time based on a concatenation of (a) the memory for the layer at a last time and (b) an input to the layer at the time.

28. The system of claim 21 wherein the code, when executed by the one or more processors, further performs to feed back an input to a last layer of the decoder to an input of a layer of the decoder that is arranged before the last layer of the decoder.

29. The system of claim 21 wherein the code, when executed by the one or more processors, further performs to feedback an input to a last layer of the decoder to inputs of all layers of the decoder that are arranged before the last layer of the decoder.

30. The system of claim 21 wherein the decoder includes at least three decoder layers.

31. The system of claim 21 wherein the code, when executed by the one or more processors, performs to:
receive a time series of images including more than the three or more images;
segment the time series of images into segments of the images, each of the segments including a predetermined number of images that are also included in at least one other one of the segments; and
process the segments using the neural network to generate pointmaps of the scene that correspond to the segments.

32. The system of claim 21 wherein the code, when executed by the one or more processors, performs to align the pointmaps of the segments.

33. The system of claim 32 wherein the code, when executed by the one or more processors, performs to segment the time series of images into segments each including a second predetermined number of the images of the time series, wherein the predetermined number is less than the second predetermined number.

34. The system of claim 33 wherein the predetermined number is one-quarter of the second predetermined number.

35. The system of claim 21 wherein the code, when executed by the one or more processors, performs to align the pointmaps in the common coordinate frame.

36. The system of claim 35 wherein the code, when executed by the one or more processors, performs to align the pointmaps based on poses of the imaging device for the segments, respectively.

37. The system of claim 21 wherein the code, when executed by the one or more processors, performs to:
create a structure of image descriptors for the segments;
for each image descriptor, perform a nearest neighbor search in the structure;
determine similarity scores between pairs of images in the segments;
identify pairs of images with similarity scores that are greater than a predetermined value;
identify two of the segments as a loop based on the two of the segments having at least a third predetermined number of the pairs with similarity scores greater than the predetermined value;
form a new segment based on first ones of the images surrounding the pairs of images; and
process the new segment using the neural network to generate a new pointmap of the scene that corresponds to the new segment.

38. The system of claim 37 wherein the code, when executed by the one or more processors, performs to align the new pointmap with the pointmaps in the common coordinate frame.

39. The system of claim 38 wherein the alignment includes aligning based on poses of the imaging devices.

40. The system of claim 21, wherein the three or more images are overlapping segments of a time series of images.

41. A computer-implemented method for reconstructing a scene in three dimensions from a plurality of images of one or more viewpoints of the scene acquired using one or more imaging devices, comprising:
(a) decoding a first image and a second image;
(b) concatenating the decoded first and second images to form a memory;
(c) encoding a third or subsequent image;
(d) applying a sequence of decoder layers with cross-attention to the third or subsequent image and the memory;
(e) for the third or subsequent image, computing a pointmap of the scene corresponding to such third or subsequent image that is aligned in a common coordinate frame that is common with the first image, the second image and the third or subsequent image;
(f) determining whether to add the third or subsequent image to the memory based when the third or subsequent image includes a new part of the scene or a different viewpoint of the scene;
(g) repeating (c)-(f) for each of the plurality of images subsequent to the third image; and
(h) outputting the pointmaps of the scene that are aligned in the common coordinate frame that is common with the first image, the second image, the third image and any subsequent image processed at (g),
wherein each pointmap is a one-to-one mapping between pixels of one of the plurality of images and three-dimensional points of the scene.

42-70. (canceled)
